(19) United States
(12) Patent Application Publication
(10) Pub. No.: US 2010/0020869 A1
(43) Pub. Date: Jan. 28, 2010

(54) CODING RATE CONVERSION DEVICE AND CODING RATE CONVERSION METHOD

(76) Inventor: Hiroshi Ikeda, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/521,918

(22) PCT Filed: Mar. 27, 2008
(86) PCT No.: PCT/JP2008/000775

§ 371 Date: Jul. 1, 2009

(30) Foreign Application Priority Data
Mar. 28, 2007 (JP) 2007-083717

(51) Int. Cl. H04N 7/12

(52) U.S. Cl. 375/240.03; 375/E07.198

(57) ABSTRACT

A coding rate conversion device can easily avoid the possibility of a violation of the standard taking place when all of the coded blocks included in a macroblock are to be deleted, with a high degree of efficiency in rate conversion performed when an MPEG-2 coding rate is converted through requantization. The coding rate conversion device performs a rate conversion on first coded data by inversely quantizing the first coded data having been quantized with a first quantization step and requantizing the first coded data with a second quantization step larger in step size than the first quantization step. The coding rate conversion device includes: a block specifying unit which specifies an object block having a nonzero coefficient, out of a plurality of blocks included in the first coded data; and a non-zeroing unit which performs non-zeroing processing by which a first nonzero coefficient of the specified object block become a nonzero coefficient even after the rate conversion is performed using the second quantization step, when the rate conversion is performed on the specified object block.

### TECHNICAL FIELD

The present invention relates to a coding rate conversion device and a coding rate conversion method, and particularly relates to a coding rate conversion device and a coding rate conversion method whereby a coding rate is converted so that the information amount of coded data is further reduced. More specifically, the present invention relates to a coding rate conversion device and a coding rate conversion method whereby the efficiency of processing performed for the coding rate conversion is improved and the coding standard is adhered to even after the coding rate conversion is performed.

### BACKGROUND ART

In recent years, the MPEG-2 (Moving Picture Experts Group 2) standard which realizes high compression has been adopted as a picture coding technique. This picture coding technique is used in digital broadcasting and for record media such as a DVD. This picture coding technique allows a bit rate to be selectable within a certain range depending on the intended use.

Moreover, when a high-quality digital broadcast is to be recorded onto a record medium, data of the high-quality digital broadcast is converted at a coding rate which decreases a bit rate in order to reduce the information amount of the data, instead of recording the data as it is onto the record medium. As a result, a lot of data can be recorded onto the record medium. Also, for the case where picture coded data is recorded onto a record medium, there is an increasing need for high speed dubbing or the like whereby when the picture coded data is recorded, the coding rate is converted so as to make effective use of the capacity of the record medium.

As the coding rate conversion method, there is an open-loop conversion method, for example. When this method is employed, instead of decoding an input bitstream (referred to as a coded stream, hereafter) down to the pixel level to convert the coding rate, DCT (Discrete Cosine Transform) coefficients obtained after the coded stream is inversely quantized are requantized in a different quantization step to convert the coding rate. Using this method, the amount of data of the coded stream is converted into a desired amount of data.

Here, a detailed explanation is given about an MPEG-2 DCT coefficient.

FIG. 1 is a diagram showing a relation among a slice, a macroblock, blocks, a CBP, and DCT coefficients. FIG. 2 is a diagram showing coding orders (scanning orders) in which the MPEG-2 DCT coefficients are coded.

As shown in FIG. 1, one picture includes one or more slices according to the MPEG-2 standard. One slice includes one or more macroblocks (MB: Macroblock).

Moreover, one macroblock has six blocks in total including four luminance blocks and two color difference blocks in the standard format (represented by 4:2:0). The luminance blocks and the color difference blocks are different in number because these numbers are determined based on the visual feature that human eyes are more sensitive to luminance than color differences.

According to the MPEG-2 standard, the six blocks are coded in the following order: a luminance Y (upper left), a luminance Y (upper right), a luminance Y (lower left), a luminance Y (lower right), a color difference Cb (blue component), and a color difference Cr (red component).

Here, a block which does not have a DCT coefficient that is not zero (i.e., a nonzero DCT coefficient), that is, a block which has only zero DCT coefficients, is omitted from the coding, and thus only the blocks having nonzero DCT coefficients are coded. Whether a block has a nonzero DCT coefficient is indicated by a CBP (Coded Block Pattern).

The CBP shows whether the blocks have nonzero coefficients by indicating a block having a nonzero coefficient (a coded block) as 1 and a block not having a nonzero coefficient (an all-zero-coefficient block) as 0. The CBP shows the blocks in coding order.

In FIG. 1, for example, when only the luminance Y (upper right), the luminance Y (lower left), and the color difference Cr (red component) have nonzero DCT coefficients (that is, they are coded blocks), the CBP is 011001 in binary form.

Next, the DCT coefficients of the coded block are first quantized and, as a result, the quantized DCT coefficients are obtained. After this, in zigzag scanning order or alternate scanning order shown in FIG. 2, only the nonzero quantized DCT coefficients (described as the nonzero coefficients hereafter) are coded.

Here, the zigzag scanning is suitable for coding a progressive picture whereas the alternate scanning is suitable for coding an interlaced picture. Although an explanation given below is about the case where the zigzag scanning is employed, the same discussion can be made about the alternate scanning.

The coding of the nonzero coefficient is organized as: “run” indicating the number of items counted from the previous nonzero coefficient to the current coding-object nonzero coefficient, that is, “run” indicating the number of consecutive zero coefficients which precede in the zigzag scanning order; and “level” which is a value of the nonzero quantized DCT coefficient. Also, when the nonzero coefficients are coded, an EOB (End Of Block) is added and coded after the last nonzero coefficient in order to indicate the end of the nonzero coefficients. The zero coefficients that follow after this are omitted.

For example, the quantized DCT coefficients of the coded block shown in FIG. 1 are coded from low-frequency components in the following order: 7, 3, 0, 0, 1, and then all 0 after this. For the block in which the quantized DCT coefficients exist, the coding is performed in order as follows: (run, level)=(0, 7), (0, 3), (2, 1), and the EOB.

Next, a detailed explanation is given about a coded stream structure of an MPEG-2 macroblock (MB).

FIG. 3 is a diagram showing a syntax flow of the coding information of the entire MPEG-2 macroblock.

The coding information of the MB includes an MB header part in S301 and a block part in S302 in this order.

When the MPEG-2 macroblock (MB) is a skip MB that is to be skipped, the information of the MB header part (S301) and the block part (S302) is not coded. The presence or absence of the skip MB can be determined by reference to an MB address increment included in the MB header part of a next non-skip MB.

It should be noted that, aside from the skip MB, the MB header part always exists. The block part exists only when an MB type included in the MB header part is “Intra” or “Coded”. Moreover, the block part repeats corresponding to the number of coded blocks indicated by the CBP included in the MB header part.

FIG. 4 is a diagram showing a syntax flow of the coding information of an MPEG-2 MB header part.

In the following order, the coding information of the MB header part includes: an MB address increment (macroblock_address_increment) in S401; an MB type (macroblock_type) in S402; a motion compensation type (motion_type) in S403; a DCT type (dct_type) in S404; a quantization scale code (quantizer_scale_code) in S405; forward motion vectors (motion_vectors (0)) in S406; backward motion vectors (motion_vectors (1)) in S407; and a CBP (coded_block_pattern) in S408.

It should be noted that although the MB address increment and the MB type always exist, the presence or absence of the other information is determined from the header information other than the MB address increment and from the MB type.

FIG. 5 is a diagram showing a syntax flow of the coding information of an MPEG-2 block part.

The structure of the coding information of the block part is different depending on whether the current MB is an Intra MB on which the motion compensation is not to be performed or an Inter MB on which the motion compensation is to be performed. Whether the current MB belongs to which of these is determined from the MB type.

When the MB is an Intra MB, only one DC component (dct_dc_size, dct_dc_diff) of the DCT coefficient is first coded in S501. Since the quantization step of the DC coefficient is fixed, the DC coefficient is not affected by a value of the quantization scale code included in the MB header. The coefficients other than the DC component are AC components (run, level), and the coding is performed corresponding to the number of the nonzero quantized DCT coefficients in 5502.

It should be noted that the number of the AC components out of the DCT coefficient values of the Intra MB depends on the value of the quantization scale code included in the MB header.

When a nonzero coefficient does not exist in the AC components, the coding is not performed.

Moreover, when the block size is 8×8=64 as shown in FIG. 1, one DC component exists and, for this reason, there is a possibility that 63 AC components may be coded at the maximum.

The EOB is coded at the end of the block in S503.

When the MB is an Inter MB and the MB type is “Coded”, one or more AC components (run, level) are certainly coded in S502. For example, when the block size is 8×8=64 as shown in FIG. 1, no DC component exists in the Inter MB and, for this reason, there is a possibility that 64 AC components may be coded at the maximum.

As is the case with the Intra MB, the EOB is coded at the end of the block in S503.

FIG. 6 is a diagram showing a relation among the quantization scale code and the quantization steps according to the MPEG-2 standard.

The quantization step used in quantizing the AC coefficient is derived from the quantization scale code included in the MB header on the basis of the table shown in FIG. 6.

Next, a detailed explanation is given about the open-loop rate conversion method, by making a comparison between a common MPEG decoding device and a common MPEG coding device.

FIG. 7 is a diagram showing a configuration of an MPEG decoding device 700.

The MPEG decoding device 700 includes a variable length decoding unit 701, an inverse quantization unit 702, an inverse DCT transformation unit 703, a reference frame storage unit 704, a motion compensation unit 705, and a picture reconstruction unit 706.

The variable length decoding unit 701 decodes an MPEG-2 coded stream, and notifies the inverse quantization unit 702 of the quantized DCT coefficients as block information.

First, an explanation is given about the case of the Intra MB.

The inverse quantization unit 702 inversely quantizes the notified quantized DCT coefficient back to the DCT coefficient, and notifies the inverse DCT transformation unit 703 of the inverse-quantized DCT coefficient.

The inverse DCT transformation unit 703 performs inverse DCT transformation on the notified DCT coefficient so as to obtain pixel information back. An output of the obtained pixel information is provided via the picture reconstruction unit 706.

Moreover, since there is a possibility that the pixel information may be referenced for pictures that follow, the obtained pixel information is stored in the reference frame storage unit 704.

Next, an explanation is given about the case of the Inter MB.

The inverse quantization unit 702 inversely quantizes the notified quantized DCT coefficient back to the DCT coefficient, and notifies the inverse DCT transformation unit 703 of the inverse-quantized DCT coefficient.

The inverse DCT transformation unit 703 performs inverse DCT transformation on the notified DCT coefficient so as to obtain pixel information back. An output of the obtained pixel information is provided via the picture reconstruction unit 706.

Moreover, since the pixel information obtained through the inverse DCT transformation is a difference value, further processing is required after the output is provided to the picture reconstruction unit 706.

The motion compensation unit 705 obtains the reference picture specified by the motion vector decoded by the variable length decoding unit 701 from the reference frame storage unit 704, and notifies the picture reconstruction unit 706 of the obtained reference picture.

The picture reconstruction unit 706 obtains the pixel information by adding a difference between the reference picture and the pixel information, and provides the output of the obtained pixel information. As is the case with the Intra MB, the reconstructed pixel information is stored in the reference frame storage unit 704.

FIG. 8 is a diagram showing a configuration of an MPEG coding device 800. Basically, the configuration is opposite to that of the MPEG decoding unit 700.

The MPEG coding device 800 includes a DCT transformation unit 801, a quantization unit 802, a variable length coding unit 803, an inverse quantization unit 804, an inverse DCT transformation unit 805, a reference frame storage unit 806, a motion compensation unit 808, a pixel subtraction unit 809, a pixel addition unit 810, and a rate control unit 811.

First, an explanation is given about the case of the Intra MB.

The DCT transformation unit 801 performs DCT transformation on the pixel information received via the pixel subtraction unit 809, and notifies the quantization unit 802 of the pixel information.

The rate control unit 811 calculates a quantization step while modifying a target coding rate by the actual result of the number of coded bits obtained from the variable length coding unit 803, and notifies the quantization unit 802 of the calculated quantization step.

The quantization unit 802 quantizes the DCT-transformed DCT coefficient of the pixel information using the quantization step calculated by the rate control unit 811, and notifies the variable length coding unit 803 of the quantized DCT coefficient. At the same time, the quantization unit 802 notifies the inverse quantization unit 804 of the quantized DCT coefficient so that the quantized DCT coefficient is used as a reference picture.

The variable length coding unit 803 codes the notified quantized DCT coefficient as a coded stream.

Here, the quantized DCT coefficient is decoded down to the pixel information by the inverse quantization unit 804 and the inverse DCT transformation unit 805 and then stored in the reference frame storage unit 806 so as to be used as a reference picture for pictures that follow, as is the case with the MPEG decoding device 700.

Next, an explanation is given about the case of the Inter MB.

The motion detection unit 807 reduces the amount of the picture information of the input picture, using the reference picture.

The motion detection unit 807 detects a picture (the reference picture) which has a high degree of similarity to the input picture from the reference frame storage unit 806, and calculates a motion vector. The calculated motion vector is notified to the motion compensation unit 808 as well as to the variable length coding unit 803. The variable length coding unit 803 codes the notified motion vector as the MB header information of the coded stream.

On the basis of the motion vector, the motion compensation unit 808 obtains the reference picture from the reference frame storage unit 806. The pixel subtraction unit 809 calculates a difference between the obtained reference picture and the input picture and, as a result, the motion compensation unit 808 reduces the amount of information.

After this, the processing performed by the DCT transformation unit 801, the quantization unit 802, the variable length coding unit 803, the inverse quantization unit 804, the inverse DCT transformation unit 805, the reference frame storage unit 806, and the rate control unit 811 is the same as in the case of the Intra MB and, therefore, the explanation is omitted here.

The pixel addition unit 810 adds the reference picture obtained by the motion compensation unit 808 to the difference of the picture information calculated from the quantized DCT coefficient by the inverse quantization unit 804 and the inverse DCT transformation unit 805 in order for the picture to be used as a reference picture in pictures that follow. As a result, the picture information can be obtained. This decoded picture information is stored in the reference frame storage unit 806.

Here, according to the MPEG-2 standard, the number of bits of the MB header part is approximately within a certain range and makes up a small percentage of the number of bits of the entire coded stream. On the other hand, the number of bits of the block part varies greatly from one MB to another, and makes up a large percentage of the number of bits of the entire coded stream.

With this being the situation, in order to decrease the coding rate to reduce the number of bits of the coded stream, it is effective to increase the quantization step of the MB and decrease the quantized DCT coefficient value (level) of the block part. This is because a low-value level can be expressed by a small number of coded bits, and when the level is 0, the coding itself does not need to be performed on this level.

FIG. 9 is a diagram showing an example of a configuration of an open-loop coding rate conversion device 900. The open-loop coding rate conversion device 900 is a conversion device employing the above-mentioned property of the requantization. The open-loop coding rate conversion device 900 shown in FIG. 9 is constructed by connecting the MPEG decoding device 700 and the MPEG coding device 800 and removing unnecessary components. Instead of decoding the coded stream down to the picture level, this coding rate conversion device 900 converts the coding rate only by requantizing the inversely quantized DCT (Discrete Cosine Transform) coefficient using a different quantization step. On this account, DCT transformation and motion compensation do not need to be performed.

The coding rate conversion device 900 includes a variable length decoding unit 901, a variable length coding unit 902, a rate control unit 903, a Q value conversion unit 904, a header storage unit 905, an inverse quantization unit 906, and a quantization unit 907.

The variable length decoding unit 901 decodes an input MPEG-2 coded stream. The variable length decoding unit 901 notifies the header storage unit 905 of parameters of an MB header part of the decoded coded stream. At the same time, the variable length decoding unit 901 converts a quantization scale code included in the MB header of the decoded coded stream to a quantization step, and notifies the Q value conversion unit 904 of the converted quantization step.

Moreover, the variable length decoding unit 901 notifies the inverse quantization unit 906 of parameters of the block part of the decoded coded stream, such as the quantized DCT coefficients.

The rate control unit 903 calculates a target quantization step, in accordance with a target conversion rate. The rate control unit 903 notifies the Q value conversion unit 904 of the calculated target quantization step.

From the quantization step at the time of input and the target quantization step received from the rate control unit 903, the Q value conversion unit 904 determines a new quantization step to be used at the time of output. To be more specific, from the quantization step of the coded stream decoded by the variable length decoding unit 901 and the target quantization step notified by the rate control unit 903, the Q value conversion unit 904 determines the new quantization step for the stream to be re-coded and provided by the variable length coding unit 902.

The Q value conversion unit 904 notifies the quantization unit 907 of the determined new quantization step and, at the same time, notifies the header storage unit 905 of the new quantization step.

The header storage unit 905 converts the quantization step notified by the Q value conversion unit 904 into a quantization scale code, and replaces the parameters in the MB header part of the stream notified by the variable length decoding unit 901 with new values.

Moreover, the header storage unit 905 notifies the variable length coding unit 902 of the parameters corresponding to the MB header part. Accordingly, the variable length coding unit 902 obtains the stream of the MB header part.

The quantization unit 907 performs quantization in accordance with the new quantization step determined by the Q value conversion unit 904. The quantization unit 907 notifies the variable length coding unit 902 of the quantization DCT coefficients obtained as a result of the quantization. Accordingly, the variable length coding unit 902 obtains the stream of the block part.

The rate control unit 903 obtains the number of decoded bits from the variable length decoding unit 901 and the number of coded bits, coded by the variable length coding unit 902, from the variable length coding unit 902, and accordingly modifies the target rate whenever necessary.

Next, an explanation is given on a concrete example of the open-loop coding rate conversion.

FIGS. 10, 11, and 12 are diagrams showing examples of conversion performed by the open-loop coding rate conversion device 900.

As shown in FIG. 10, suppose that there is a block including total eight nonzero quantized DCT coefficients (levels) 7, −3, 2, 1, 4, 1, −1, and 1 which are all AC components. Here, suppose that the quantization step is 4 at the time of input and is to be converted into 8 at the time of output.

The quantized DCT coefficients (levels) become 3, −1, 1, 0, 2, 0, 0, and 0 respectively (fractional portions are discarded in this case here). The level values become smaller, and the number of nonzero coefficients (nonzero quantized DCT coefficients) is decreased from eight before the conversion to four after the conversion. Also, more zero coefficients continue in a row, thereby increasing the run in value.

For example, the run of the fourth coefficient is 3 at the time of input. Then, since the level changes to 0, the fifth coefficient at the time of input is advanced to the fourth and the run changes into 4.

When the coding is performed here, the amount of coding is decreased from 50 bits at the time of input to 25 bits. Therefore, it can be understood that the open-loop coding rate conversion is effective.

However, in the case of a block including three nonzero coefficients (levels) in total which are 1, −1, and 1 (all AC components) as shown in FIG. 11, the quantized DCT coefficients (levels) all become 0 (fractional portions are discarded) when the quantization step is converted from 4 to 8. This may happen only to the Inter MB because the Intra MB always has a DC component which does not change even when the quantization step is changed.

According to the MPEG-2 standard, in the case of a block which does not include a nonzero DCT coefficient, it is necessary to set a corresponding flag of the CBP to 0 (meaning an all-zero-coefficient block) without exception. In other words, it is against the standard to reach the EOB without a DCT coefficient in the block. For this reason, the CBP at the time of input needs to be rewritten in such a case.

Yet, as shown in FIG. 12, when four coded blocks exist originally in the MB and then the DCT coefficients are all converted into 0, there would be no coded block.

However, the MPEG-2 standard prohibits CBP=0 to be coded. For this reason, the MB type in the MB header part needs to be changed from “Coded” to “Not Coded”.

Here, an explanation is given about the kinds of MPEG-2 MB types.

FIG. 13 is a diagram showing the kinds of the MPEG-2 MB types.

Since the Intra MB always have a DC component of a DCT coefficient, there is no need to draw a distinction between “Coded” and “Not Coded”. On the other hand, since the Inter MB may not have a code of a DCT coefficient, there is a need to draw a distinction between “Coded” and “Not Coded”.

When there is no coded block that exists after the rate conversion, that is, when the MB type at the time of input is “Interp, Coded” of a B picture for example, the MB type at the time of output may be converted into “Interp, Not Coded”.

When there is no coded block that exists after the rate conversion and the MB type at the time of input is “No MC, Coded” (no motion vectors, but coded blocks present) of a P picture, it is desired to convert the MB type to “No MC, Not Coded” (no motion vectors, no coded blocks). However, as shown in FIG. 13, the corresponding MB type does not exist according to the MPEG-2 standard. Thus, a stream based on the MPEG-2 standard cannot be generated.

Moreover, by setting the present macroblock to a skip MB in this case, the same effect as “No MC, Not Coded” (no motion vectors, no coded blocks) can be obtained. However, since the skip MB is expressed in the MB header part (macroblock_address_increment) of a next MB, it is impossible for the open-loop rate conversion device 900 shown in FIG. 9 to deal with this. In this case here, a complicated mechanism to rewrite the MB header of the next MB is required.

Furthermore, the MPEG-2 standard prohibits the first and last MBs of a slice from being skip MBs. That is to say, even when such a mechanism exists, a stream based on the MPEG-2 standard may not be able to be generated.

With this being the situation, some measures needs to be taken so that, even when the coding rate conversion is performed, the data after the conversion adheres to the MPEG-2 standard.

As one of the measures, a picture coding rate conversion device whereby the CBP does not change even after the coding rate conversion is disclosed in Japanese Patent Publication No. 3770466 (Patent Reference 1). To be more specific, after the coding rate conversion, it is determined whether all of the quantized DCT coefficients in the coded block are not 0. When all are 0, an instruction that a pre-conversion quantized DCT coefficient should be retained is given. With this instruction, not all of the quantized DCT coefficients included in the pre-conversion coded block become 0 after the conversion.

FIG. 14 is a diagram showing a configuration of a conventional coding rate conversion device 1400. FIG. 14 shows the configuration that realizes the same method as disclosed in Japanese Patent Publication No. 3770466.

The coding rate conversion device 1400 includes a variable length decoding unit 901, a variable length coding unit 902, a rate control unit 903, a Q value conversion unit 904, a header storage unit 905, an inverse quantization unit 906, a quantization unit 907, an all-zero-coefficient-block detection unit 1413, and a block coefficient storage unit 1415.

The variable length decoding unit 901, the variable length coding unit 902, the rate control unit 903, the Q value conversion unit 904, the header storage unit 905, the inverse quantization unit 906, and the quantization unit 907 are assigned the same numerals as those in FIG. 9. These units have the same constructions as those in FIG. 9 and, therefore, the explanations are omitted here.

The block coefficient storage unit 1415 accumulates quantized DCT coefficients of one block, which have been quantized by the quantization unit 907.

The all-zero-coefficient-block detection unit 1413 detects whether all of the quantized DCT coefficients of one block, which have been quantized by the quantization unit 907, are 0. As described above, when all of the quantized DCT coefficients of the block are 0, the CBP needs to be changed according to the MPEG-2 standard. In order to avoid this, when detecting a block in which all of the quantized DCT coefficients are 0, the all-zero-coefficient-block detection unit 1413 instructs the block coefficient storage unit 1415 to retain one of the quantized DCT coefficients existing at the time of input as “1” or “−1”. As a result, a situation where all of the quantized DCT coefficients in the block are 0 is prevented from happening. Patent Reference 1: Japanese Patent Publication No. 3770466

### DISCLOSURE OF INVENTION

Problems that Invention is to Solve

In the case of the configuration of the above-mentioned Patent Reference 1, however, although the quantized DCT coefficients after the coding rate conversion adhere to the standard, two problems are caused.

A first problem is a process of backtracking.

FIG. 15 is a diagram showing an example of conversion performed by the conventional coding rate conversion device. The backtracking process is explained, with reference to FIGS. 14 and 15.

When the quantization unit 907 shown in FIG. 14 converts a quantized DCT coefficient to 0, the block coefficient storage unit 1415 stores a value “0”. However, since there is a possibility that the quantized DCT coefficient may be changed to “1” or “−1” later, the value of the post-conversion quantized DCT coefficient cannot be finalized at this point.

According to the MPEG-2 standard, all of the quantized DCT coefficients of the block are finalized by the detection of the EOB as described above.

When no nonzero quantized DCT coefficient exists in the current block at the time of the EOB detection, the backtracking process needs to be performed. That is to say, only a specific quantized DCT coefficient is selected from among the quantized DCT coefficients which have already been converted and accumulated in the block coefficient storage unit 1415 and is restored to “1” or “−1”. In the case of the MPEG-2 standard, the specific quantized DCT coefficient is selected from among 64 DCT coefficients at the maximum and thus this backtracking process is complicated.

In the case of a coding system whereby the number of nonzero quantized DCT coefficients is known in advance, the quantized DCT coefficient is finalized as 0 at the time of the quantization of the last nonzero quantized DCT coefficient. Then, by performing processing so that the last nonzero quantized coefficient is not converted to 0, it becomes possible to restore the nonzero quantized DCT coefficient without the backtracking process. According to the MPEG-2 standard, however, before the actual detection of the EOB, the last nonzero quantized DCT coefficient is unknown at any point. On account of this, the above-mentioned processing cannot be performed.

A second problem is a decrease in coding efficiency.

FIG. 16 is a diagram showing an example of conversion performed by the conventional coding rate conversion device. An example of the decrease in coding efficiency is shown in FIG. 16.

FIG. 16(a) shows an example of the rate conversion performed in the case of the configuration of the above-mentioned Patent Reference 1 shown in FIG. 14. As described above, the configuration of the above-mentioned Patent Reference 1 shown in FIG. 14 prevents the situation where all of the coefficients in the block become 0 from happening. As shown in FIG. 16(a), one of the quantized DCT coefficients in each of the rate-converted six blocks is left as “1”. Thus, the CBP does not need to be changed in the case of the configuration of Patent Reference 1. However, although the configuration of Patent Reference 1 has an advantage that a mechanism to rewrite the CBP of the MB header part is not required, one or more quantized DCT coefficients are always left for each coded block. For example, suppose that all of the six blocks are coded blocks and the number of nonzero quantized DCT coefficients in each block is small at the time of input as shown in FIG. 16. Then, when a high-power rate conversion is performed here, the state is as shown in FIG. 16(b). To be more specific, CBP=111111 is converted to CBP=100000 through the high-power rate conversion. Yet, in the case of the configuration of Patent Reference 1, CBP=111111 remains to be CBP=111111 even after the high-power rate conversion. This is to say, even after the high-power rate conversion is performed, one or more nonzero quantized DCT coefficients always remain in each block when the configuration of Patent Reference 1 is employed. Thus, the decrease in coding efficiency caused here is not negligible.

The present invention is conceived in view of the stated problems, and an object of the present invention is to realize a coding rate conversion device and a coding rate conversion method which avoid the possibility of a violation of the MPEG-2 standard taking place when the MPEG-2 coding rate is converted, without performing the backtracking process and without a decrease in coding efficiency.

### Means to Solve the Problems

According to an aspect of the present invention, there is provided a coding rate conversion device, in order to achieve the above object, which performs rate conversion on first coded data by inversely quantizing the first coded data having been quantized with a first quantization step and by requantizing the first coded data with a second quantization step larger in step size than the first quantization step, the coding rate conversion device including: a block specifying unit which specifies an object block having a nonzero coefficient, out of a plurality of blocks included in the first coded data; and a non-zeroing unit which performs non-zeroing processing by which a first nonzero coefficient of the specified object block becomes a nonzero coefficient even after the rate conversion is performed using the second quantization step, when the rate conversion is performed on the specified object block.

With this, the backtracking process, whereby the coefficient is changed to a nonzero coefficient only after it is determined that all of the coding-object coefficients in the block are 0, does not need to be performed. Moreover, only the first coefficient of the specific coded block is changed to a nonzero coefficient (a value other than 0). On this account, for example, even when nonzero coefficients are present in the blocks other than the specific coded block and thus the specific coded block does not need to have a nonzero coefficient, the non-zeroing processing is just performed on only the first coefficient of the specific coded block. Thus, the coding rate conversion can be performed without a decrease in coding efficiency.

A configuration according to the aspect of the present invention includes the block specifying unit which changes the first nonzero coefficient of the specified coded block to a nonzero coefficient. With this, when the coding rate is converted, it can be predicted that the CBP is likely to be changed to 0. Thus, the coding rate conversion processing is performed so that the CBP does not become 0. As a result, the stream obtained after the coding rate conversion adheres to the standard, and the processing efficiency in the standard adherence processing during the coding rate conversion can be improved.

Moreover, according to another aspect of the present invention, there is provided a coding rate conversion program, in order to achieve the above object, whereby rate conversion is performed on first coded data by inversely quantizing the first coded data having been quantized with a first quantization step and by requantizing the first coded data with a second quantization step larger in step size than the first quantization step, the coding rate conversion program including: specifying an object block which has a nonzero coefficient, out of a plurality of blocks included in the first coded data; and performing non-zeroing processing by which a first nonzero coefficient of the specified object block becomes a nonzero coefficient even after the rate conversion is performed using the second quantization step, when the rate conversion is performed on the specified object block.

It should be noted that the present invention can be realized not only as a device, but also as: an integrated circuit which has processing units included in such a device; a method which has the processing units included in the device as steps; a program which causes a computer to execute these steps; and information, data, or a signal showing the program. The program, the information, the data, and the signal may be distributed via record media such as a CD-ROM or communication media such as the Internet.

### Effects of the Invention

The present invention can provide a coding rate conversion device and a coding rate conversion method which avoid the possibility of a violation of the coding standard taking place when the coding rate of the coded stream is converted, without performing the backtracking process and without a decrease in coding efficiency.

### BRIEF DESCRIPTION OF DRAWINGS

FIG. 1 is a diagram showing a relation among a slice, a macroblock, blocks, a CBP, and DCT coefficients.

FIGS. 2(a) and (b) are diagrams showing coding orders (scanning orders) in which MPEG-2 DCT coefficients are coded.

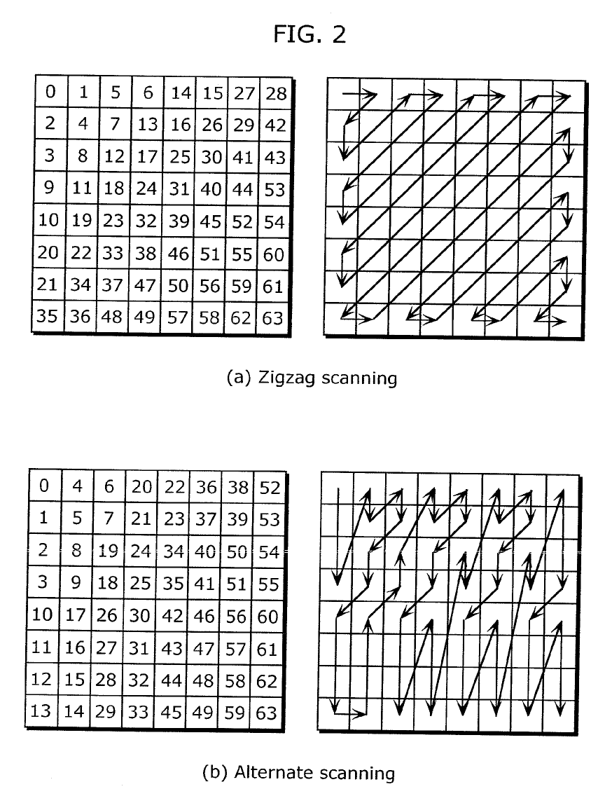

FIG. 3 is a diagram showing a syntax flow of the coding information of the entire MPEG-2 macroblock.

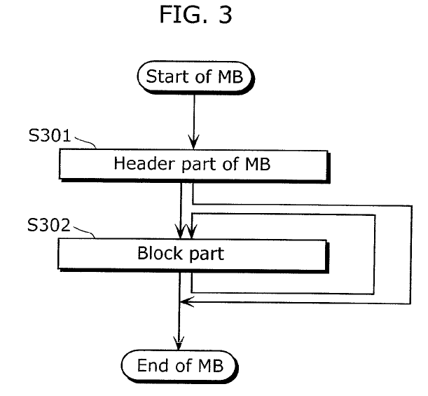

FIG. 4 is a diagram showing a syntax flow of the coding information of an MPEG-2 MB header part.

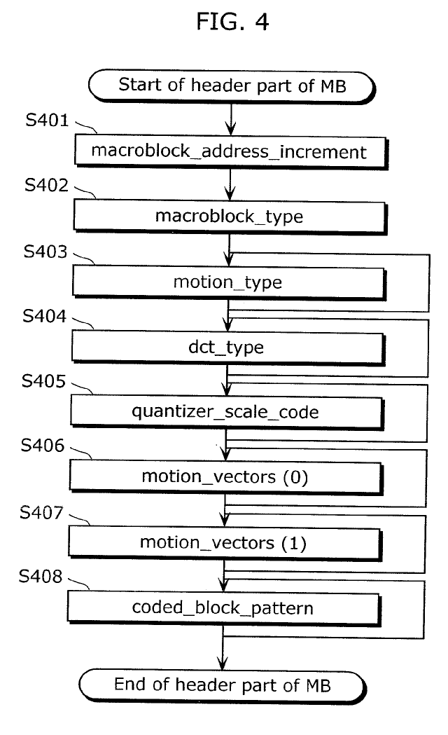

FIG. 5 is a diagram showing a syntax flow of the coding information of an MPEG-2 block part.

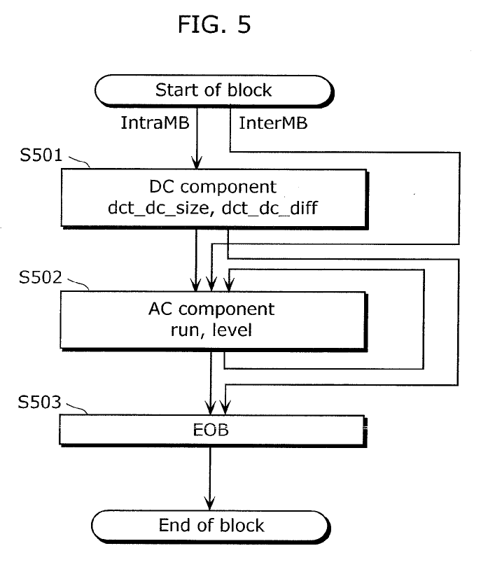

FIG. 6 is a diagram showing a relation among the quantization scale code and the quantization steps according to the MPEG-2 standard.

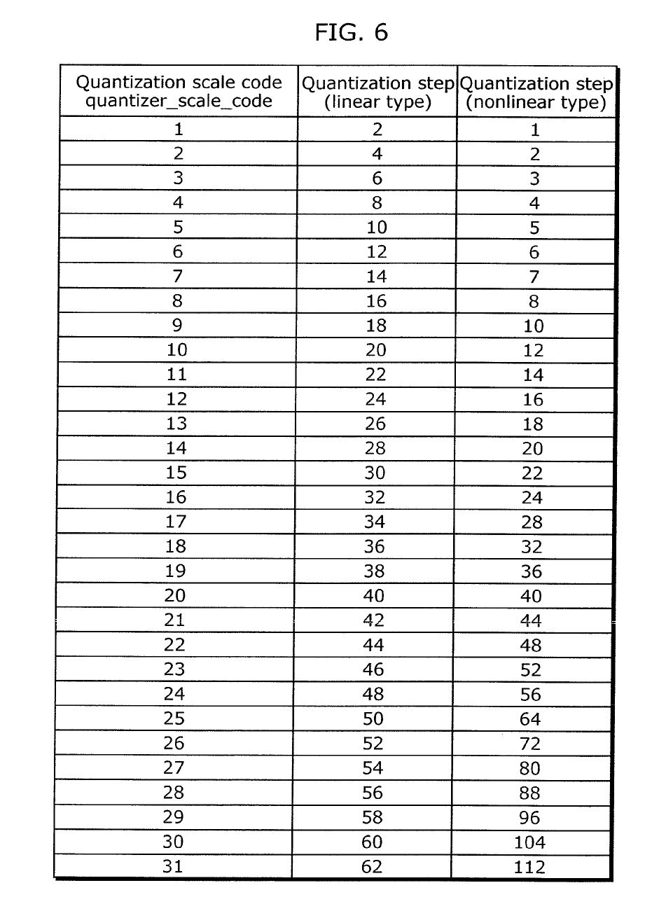

FIG. 7 is a diagram showing a configuration of an MPEG-2 decoding device.

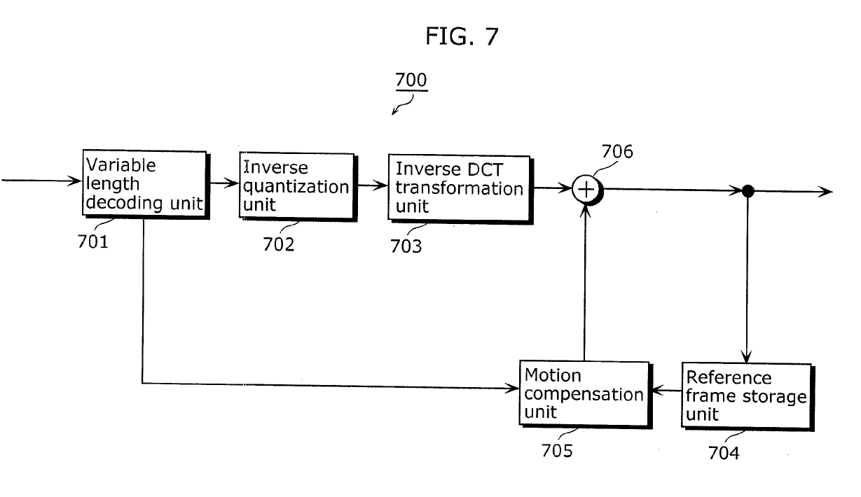

FIG. 8 is a diagram showing a configuration of an MPEG coding device.

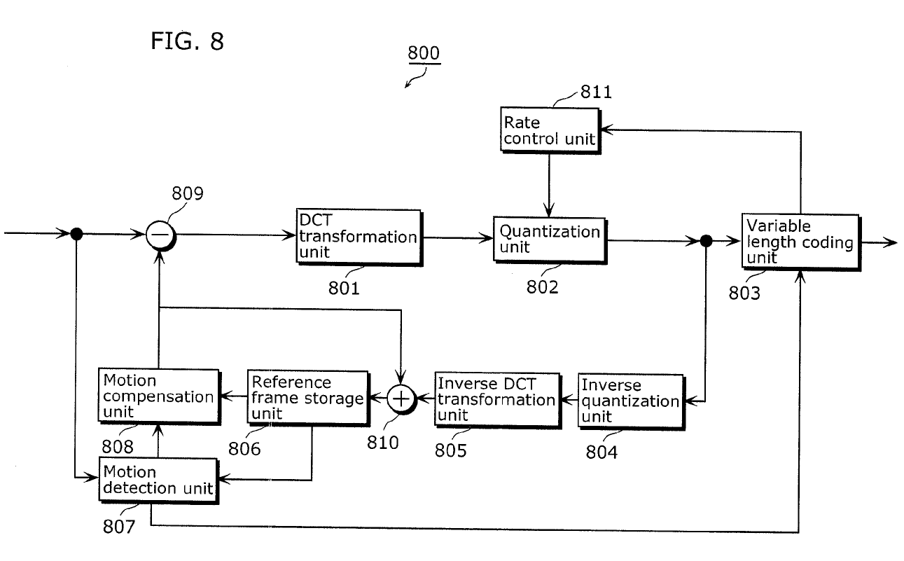

FIG. 9 is a diagram showing an example of a configuration of an open-loop coding rate conversion device.

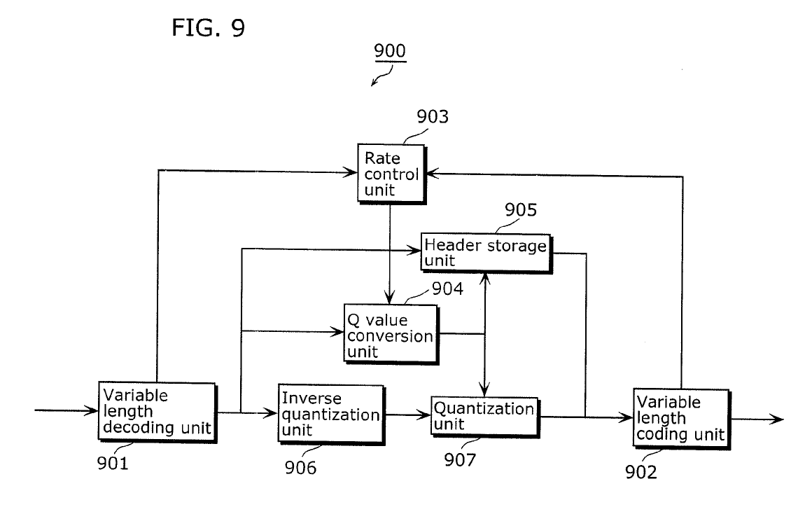

FIG. 10 is a diagram showing an example of conversion performed by the open-loop coding rate conversion device.

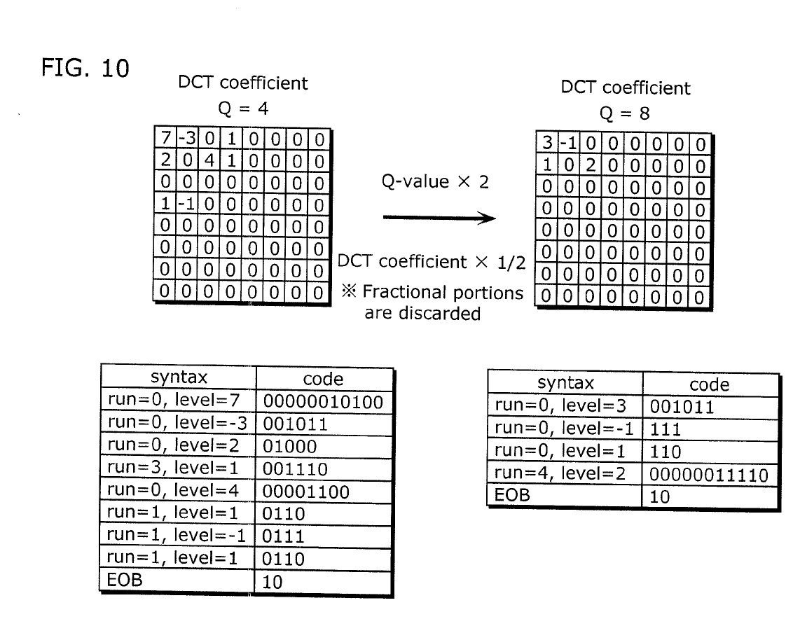

FIG. 11 is a diagram showing an example of conversion performed by the open-loop coding rate conversion device.

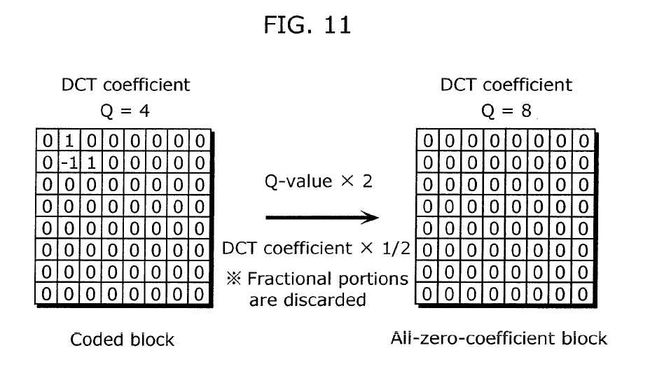

FIG. 12 is a diagram showing an example of conversion performed by the open-loop coding rate conversion device.

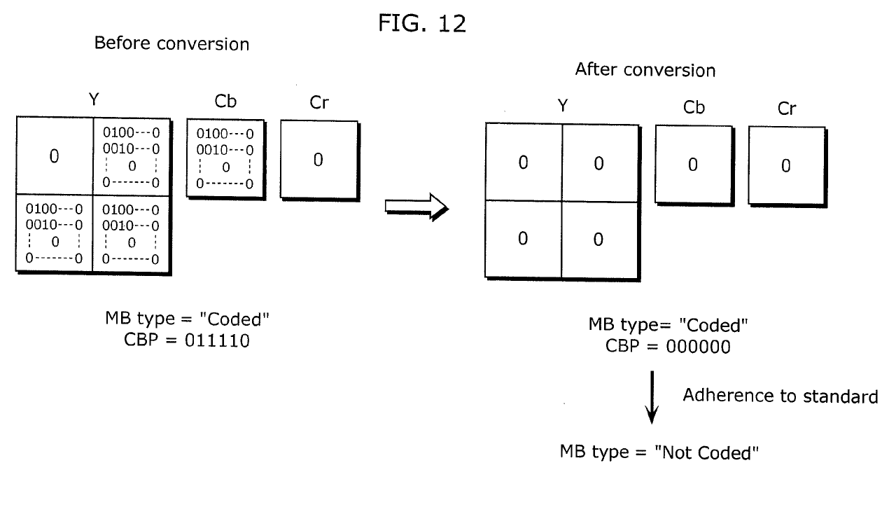

FIGS. 13(a), (b), and (c) are diagrams showing kinds of the MPEG-2 MB types.

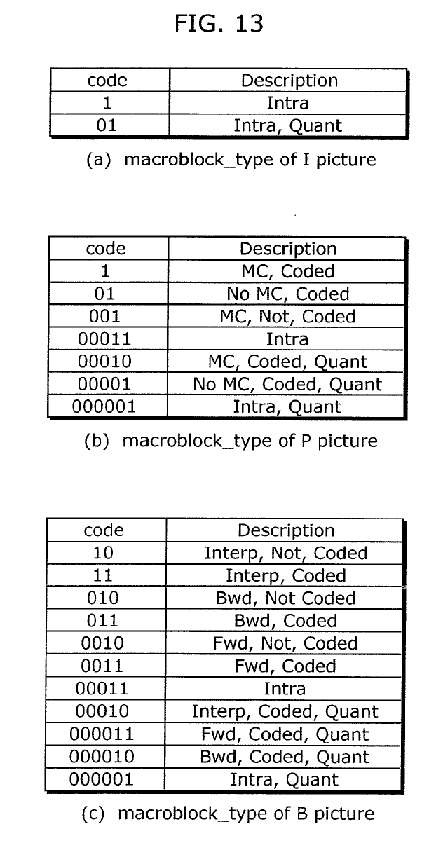

FIG. 14 is a diagram showing a configuration of a conventional coding rate conversion device.

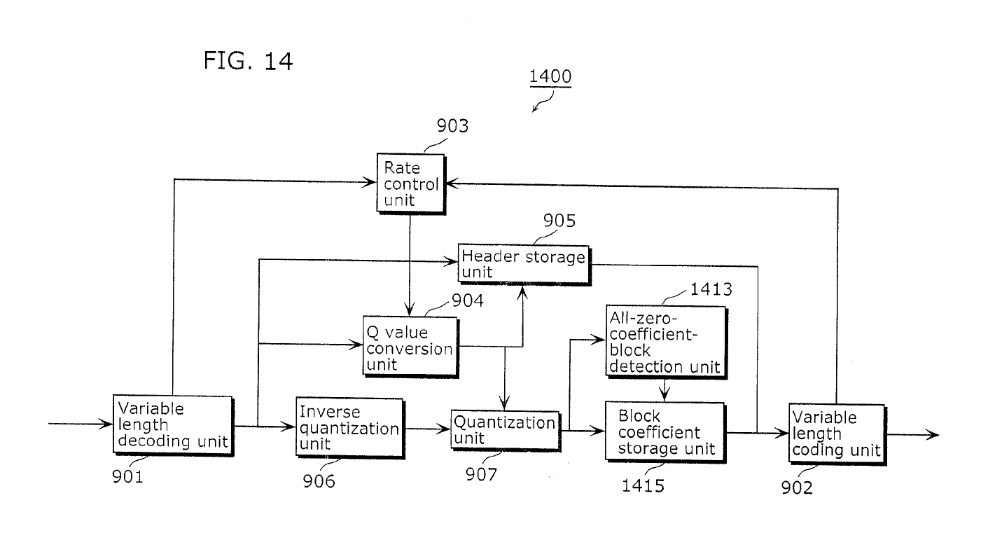

FIG. 15 is a diagram showing an example of conversion performed by the conventional coding rate conversion device.

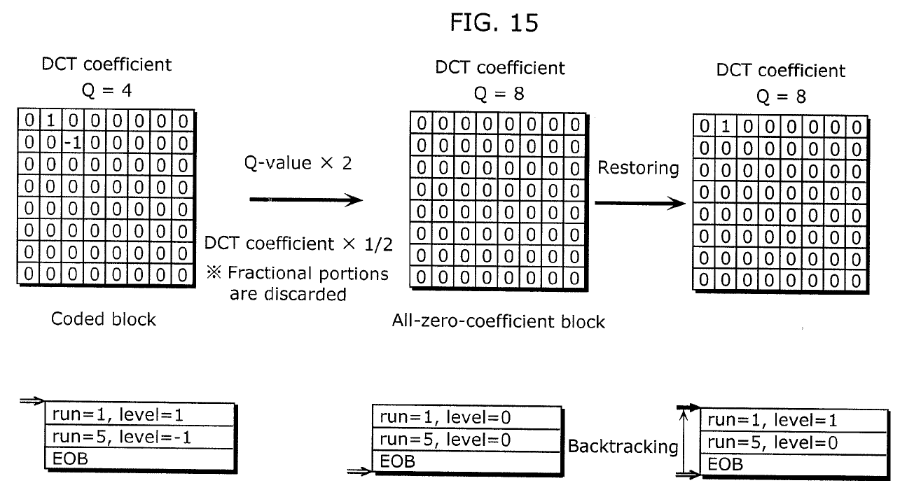

FIGS. 16(a) and (b) are diagrams showing examples of conversion performed by the conventional coding rate conversion device.

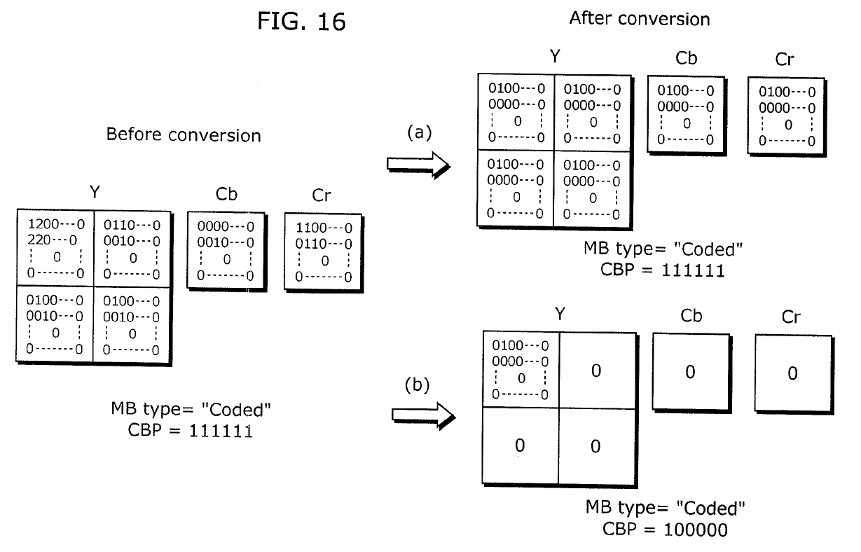

FIG. 17 is a diagram showing a configuration of a coding rate conversion device according to a first embodiment of the present invention.

FIG. 18 is a diagram showing an example of the coding rate conversion device according to the first embodiment of the present invention.

FIG. 19 is a diagram showing an example of the coding rate conversion device according to the first embodiment of the present invention.

FIG. 20 is a diagram showing an example of the coding rate conversion device according to the first embodiment of the present invention.

FIG. 21 is a flowchart showing entire-MB processing performed by the coding rate conversion device, according to the first embodiment of the present invention.

FIG. 22 is a flowchart showing last-coded-block determination processing performed by the coding rate conversion device, according to the first embodiment of the present invention.

FIG. 23 is a flowchart showing nonzero coefficient detection processing performed by the coding rate conversion device, according to the first embodiment of the present invention.

FIG. 24 is a flowchart showing all-zero-coefficient-block detection processing performed by the coding rate conversion device, according to the first embodiment of the present invention.

FIGS. 25(a) and (b) are diagrams showing examples of conversion performed by the coding rate conversion device, according to the first embodiment of the present invention.

FIG. 26 is a diagram showing an example of conversion performed by the coding rate conversion device, according to the first embodiment of the present invention.

FIG. 27 is a diagram showing an example of conversion performed by the coding rate conversion device, according to the first embodiment of the present invention.

FIG. 28 is a diagram showing an example of conversion performed by the coding rate conversion device, according to the first embodiment of the present invention.

FIG. 29 is a diagram showing a configuration of a coding rate conversion device according to a second embodiment of the present invention.

FIG. 30 is a flowchart showing last-luminance-block determination processing performed by the coding rate conversion device, according to the second embodiment of the present invention.

FIG. 31 is a flowchart showing entire-MB processing performed by the coding rate conversion device, according to the second embodiment of the present invention.

FIGS. 32(a) and (b) are diagrams showing examples of conversion performed by the coding rate conversion device, according to the second embodiment of the present invention.

FIG. 33 is a diagram showing a configuration of a coding rate conversion device according to a third embodiment of the present invention.

FIG. 34 is a flowchart showing entire-MB processing performed by the coding rate conversion device, according to the third embodiment of the present invention.

FIG. 35 is a flowchart showing first-coded-block determination processing performed by the coding rate conversion device, according to the third embodiment of the present invention.

FIG. 36 is a diagram showing an example of conversion performed by the coding rate conversion device, according to the third embodiment of the present invention.

FIG. 37 is a diagram showing a configuration of a coding rate conversion device according to a fourth embodiment of the present invention.

FIG. 38 is a flowchart showing entire-MB processing performed by the coding rate conversion device, according to the fourth embodiment of the present invention.

FIG. 39 is a diagram showing an example of conversion performed by the coding rate conversion device, according to the fourth embodiment of the present invention.

FIG. 40 is a diagram showing a configuration of a stream recording device according to a fifth embodiment of the present invention.

FIG. 41 is a diagram showing a network distribution system according to a sixth embodiment of the present invention.

### NUMERICAL REFERENCES

700 MPEG decoding device

701, 901, 1701 variable length decoding unit

702, 804, 906, 1806 inverse quantization unit

703, 805 inverse DCT transformation unit

704, 806 reference frame storage unit

705, 808 motion compensation unit

706 picture reconstruction unit

800 MPEG coding device

801 DCT transformation unit

802, 907, 1807 quantization unit

803, 902, 1702 variable length coding unit

807 motion detection unit

809 pixel subtraction unit

810 pixel addition unit

811, 903, 1703 rate control unit

900, 1400, 1700, 1800, 1900, 2000, 2900, 3300, 3700 coding rate conversion device

904, 1704 Q value conversion unit

905, 1705 header storage unit

1413, 1713 all-zero-coefficient-block detection unit

1415, 1715, 2016, 2017 block coefficient storage unit

1707 coefficient conversion unit

1708 last-coded-block detection unit

1709 nonzero coefficient detection unit

1710 non-zeroing determination unit

1711, 3711 non-zeroing unit

1712 run control unit

1714 EOB deletion unit

1907 nonzero coefficient conversion unit

2908 last-luminance-coded-block detection unit

3308 first-coded-block detection unit

3716 sign determination unit

4000 stream recording device

4001, 4101 coding rate conversion unit

4002 digital broadcast wave

4003 broadcast receiving unit

4004, 4104 AV demultiplexing unit

4005, 4105 AV multiplexing unit

4006, 4103 HDD control unit

4007, 4102 HDD

4100 network distribution system

4106, 4107 network control unit

4108 AV reproduction unit

4109 network

4110 stream sending device

4111 stream receiving device

### BEST MODE FOR CARRYING OUT THE INVENTION

The following is a description of the embodiments of the present invention, with reference to the drawings.

### First Embodiment

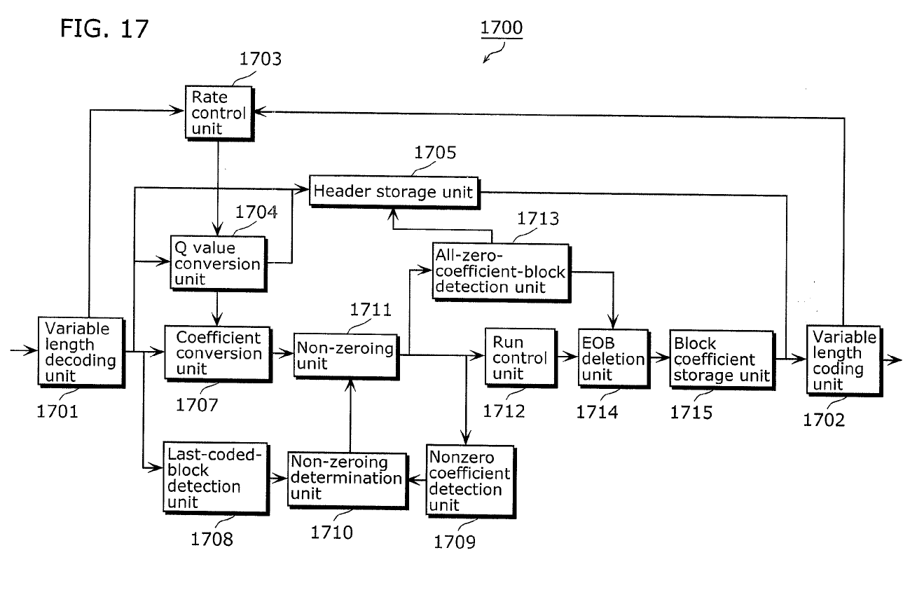

FIG. 17 is a diagram showing a configuration of a coding rate conversion device 1700 according to the first embodiment of the present invention.

The coding rate conversion device 1700 shown in FIG. 17 includes a variable length decoding unit 1701, a variable length coding unit 1702, a rate control unit 1703, a Q value conversion unit 1704, a header storage unit 1705, a coefficient conversion unit 1707, a last-coded-block detection unit 1708, a nonzero coefficient detection unit 1709, a non-zeroing determination unit 1710, a non-zeroing unit 1711, a run control unit 1712, an all-zero-coefficient-block detection unit 1713, an EOB deletion unit 1714, and a block coefficient storage unit 1715.

The variable length decoding unit 1701 decodes an MPEG-2 coded stream. The variable length decoding unit 1701 notifies the header storage unit 1705 of parameters corresponding to an MB header of the decoded coded stream. At the same time, the variable length decoding unit 1701 converts a quantization scale code included in the MB header of the decoded coded stream to a quantization step, and notifies the Q value conversion unit 1704 of the converted quantization step.

Moreover, the variable length decoding unit 1701 notifies the coefficient conversion unit 1707 of parameters, such as the quantized DCT coefficients, corresponding to the block part of the decoded coded stream, for each coefficient unit (i.e., a pair of run and level) including the EOB.

Furthermore, after the decoding of the MB of the coded stream has completed, the variable length decoding unit 1701 notifies the rate control unit 1703 of the number of bits of the MB of the decoded coded stream.

The rate control unit 1703 calculates the actual coding rate from: the number of decoded bits of the MB obtained so far by the variable length decoding unit 1701 before the coefficient conversion unit 1707 converts the coefficients of the MB of the decoded coded stream; and the number of coded bits of the MB obtained so far by the variable length coding unit 1702. The rate control unit 1703 compares the calculated actual coding rate with the target coding rate.

When the calculated actual coding rate is higher than the target coding rate, the rate control unit 1703 calculates a target quantization step by which the coding rate is lowered, and then notifies the Q value conversion unit 1704 of the calculated target quantization step. When the calculated actual coding rate is lower than the target coding rate, the rate control unit 1703 calculates a target quantization step by which the coding rate is raised, and then notifies the Q value conversion unit 1704 of the calculated target quantization step.

Before the the coefficient conversion unit 1707 converts the coefficients of the MB of the decoded coded stream, the Q value conversion unit 1704 calculates a new quantization step to be used at the time of output, from the quantization step at the time of input and the target quantization step received from the rate control unit 1703. To be more specific, from the quantization step of the coded stream decoded by the variable length decoding unit 1701 and the target quantization step notified by the rate control unit 1703, the Q value conversion unit 1704 determines the new quantization step for the stream to be coded again and provided by the variable length coding unit 1702.

The Q value conversion unit 1704 notifies the coefficient conversion unit 1707 and the header storage unit 1705 of the calculated new quantization step.

The header storage unit 1705 converts the quantization step notified by the Q value conversion unite 1704 into a quantization scale code, and replaces the parameters of the MB header part of the stream notified by the variable length decoding unit 1701 with new values.

The coefficient conversion unit 1707 obtains: the quantization step and the quantized DCT coefficients of the coded stream at the time of input from the variable length decoding unit 1701; and the target quantization step from the Q value conversion unit 1704.

In accordance with the obtained quantization step and the obtained target quantization step, the coefficient conversion unit 1707 performs the inverse quantization and the quantization on the quantized DCT coefficients. Here, the inverse quantization and the quantization are performed at the same time.

The coefficient conversion unit 1707 provides an output of the requantized DCT coefficients to the non-zeroing unit 1711.

Here, the coefficient conversion unit 1707 performs the inverse quantization and the quantization using a simple mathematical expression. This simple mathematical expression is: FQo=FQi×(Qi/Qo).

A DCT coefficient F obtained when the inverse quantization is performed can be obtained by F=α×W×Qi×FQi (where α is a constant, W is a quantization matrix, Qi is the quantization step at the time of input, and FQi is the quantized DCT coefficient at the time of input). Similarly, a quantized DCT coefficient FQo obtained when the quantization is performed can be obtained by FQo=F/(α×W×Qo) (where Qo is the quantization step at the time of output).

By integrating these expressions, the above simple mathematical expression can be obtained, thereby allowing the inverse quantization and the quantization to be performed at the same time. By performing the coefficient conversion at one time using this simple mathematical expression, the calculation can be simplified as compared to the case where the inverse quantization and the quantization are performed separately.

When receiving the quantized DCT coefficient which has been converted into 0 by the coefficient conversion unit 1707, the run control unit 1712 deletes this quantized DCT coefficient having been converted into 0 and does not notify the block coefficient storage unit 1715 of this coefficient. When next receiving a nonzero quantized DCT coefficient, the run control unit 1712 adds the number of quantized DCT coefficients which had been converted into 0 and were thus deleted to the run and notifies the block coefficient storage unit 1715 of the run obtained as a result of the addition.

The all-zero-coefficient-block detection unit 1713 is notified of the quantized DCT coefficients requantized by the coefficient conversion unit 1707, via the non-zeroing unit 1711. From the notified quantized DCT coefficients, the all-zero-coefficient-block detection unit 1713 detects whether or not the EOB is reached without a nonzero quantized coefficient in the block.

When detecting that the EOB is reached without a nonzero quantized coefficient in the block, the all-zero-coefficient-block detection unit 1713 notifies the EOB deletion unit 1714 to delete the EOB because a block having only the EOB is against the MPEG-2 standard. On the basis of the notification from the all-zero-coefficient-block detection unit 1713, the EOB deletion unit 1714 deletes the EOB of this block.

Also, at the same time, the all-zero-coefficient-block detection unit 1713 notifies the header storage unit 1705 to change the CBP of the MB header part included in this block. On the basis of the notification from the all-zero-coefficient-block detection unit 1713, the header storage unit 1705 performs processing to change the CBP of the MB header part.

The last-coded-block detection unit 1708 receives the CBP and the block information from the variable length decoding unit 1701. From the received CBP and the received block information, the last-coded-block detection unit 1708 detects the last block, out of the coded blocks (the CBP), that has the nonzero DCT coefficient and also detects the first quantized DCT coefficient out of the quantized DCT coefficients included in this last block.

The last-coded-block detection unit 1708 notifies the non-zeroing determination unit 1710 of this detection result.

The nonzero coefficient detection unit 1709 detects, for each of a plurality of blocks of the MB received from the variable length decoding unit 1701 and rate-converted by the coefficient conversion unit 1707, whether or not the requantized DCT coefficients in the block include at least one nonzero coefficient.

When detecting the nonzero coefficient in each of the plurality blocks of the MB, the nonzero coefficient detection unit 1709 notifies the non-zeroing determination unit 1710 about this.

From the notification from the nonzero coefficient detection unit 1709, when it is the first coefficient of the last coded block out of the plurality of blocks of the MB having the nonzero quantized DCT coefficients and no nonzero coefficient has been detected by the nonzero coefficient detection unit 1709, the non-zeroing determination unit 1710 notifies the non-zeroing unit 1711 to prohibit the zeroing processing.

The non-zeroing unit 1711 receives the quantized DCT coefficients requantized by the coefficient conversion unit 1707.

Only when the first coefficient of the last coded block out of the plurality of blocks of the MB is the quantized DCT coefficient having been converted into 0 by the coefficient conversion unit 1707 and the prohibition of the zeroing processing has been notified by the non-zeroing determination unit 1710, the non-zeroing unit 1711 replaces this quantized DCT coefficient with a nonzero value, such as “1”.

At the end of the conversion for one entire MB, the header storage unit 1705 notifies the variable length coding unit 1702 of the parameters of the MB header part. The variable length coding unit 1702 obtains the stream of the MB header part.

The block coefficient storage unit 1715 notifies the variable length coding unit 1702 of the coefficients of the block part. The variable length coding unit 1702 obtains the stream of the block pa rt.

Accordingly, the variable length coding unit 1702 obtains the MPEG-2 stream.

Here, configurations of other than the configuration of the coding rate conversion device 1700 shown in FIG. 17 are explained.

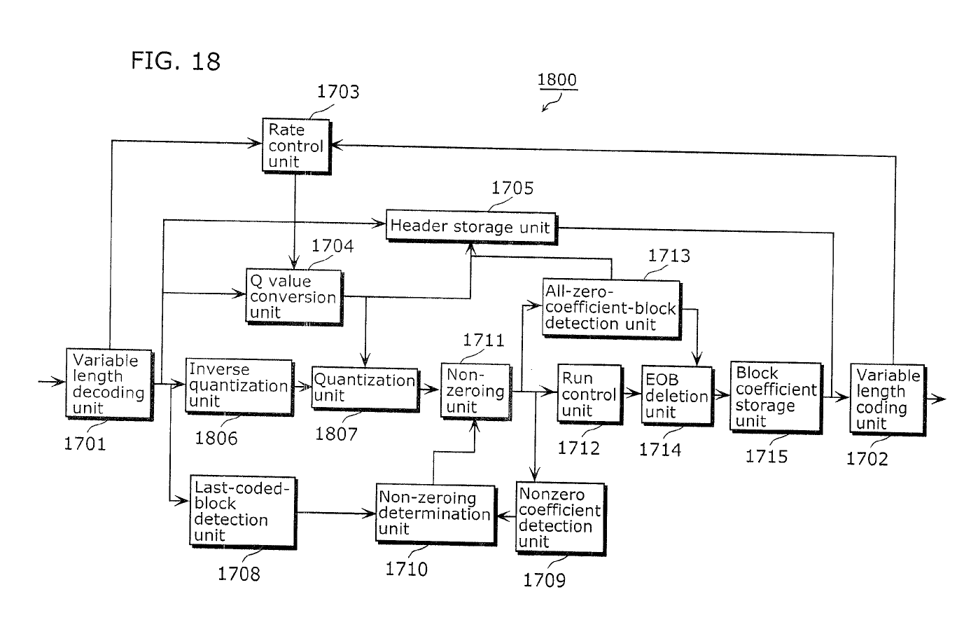

FIGS. 18, 19, and 20 are diagrams showing different examples of the coding rate conversion device 1700 in the first embodiment of the present invention. The same components as those in FIG. 17 are assigned the same numerals used in FIG. 17, and the detailed explanations about these components are omitted.

In a coding rate conversion device 1800 shown in FIG. 18, the coefficient conversion unit 1707 of the coding rate conversion device 1700 shown in FIG. 17 is replaced with an inverse quantization unit 1806 and a quantization unit 1807.

The same effect can be achieved when the coefficient conversion unit 1707 shown in FIG. 17 is separately configured as the inverse quantization unit 1806 and the quantization unit 1807 as shown in FIG. 18.

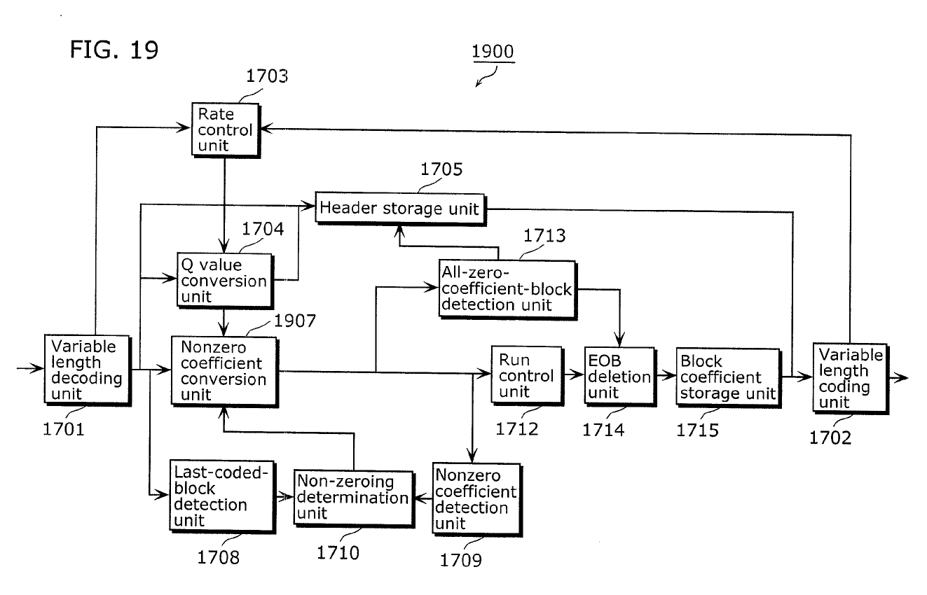

In a coding rate conversion device 1900 shown in FIG. 19, the coefficient conversion unit 1707 and the non-zeroing unit 1711 of the coding rate conversion device 1700 shown in FIG. 17 are replaced with a non-zeroing coefficient conversion unit 1907.

In the case of the coding rate conversion device 1700 shown in FIG. 17, after the coefficient conversion unit 1707 permits the conversion of the quantization DCT coefficient into 0, the non-zeroing unit 1711 independently performs the non-zeroing processing. On the other hand, in the case of the coding rate conversion device 1900 shown in FIG. 19, both of these functions are carried out at one time by the non-zeroing coefficient conversion unit 1907.

When the non-zeroing determination unit 1710 determines that the non-zeroing processing is not applied, the non-zeroing coefficient conversion unit 1907 operates according to

FQo=FQi×(Qi/Qo).

When the non-zeroing determination unit 1710 determines that the non-zeroing processing is applied, the non-zeroing coefficient conversion unit 1907 operates according to

FQo=min {FQi×(Qi/Qo), 1}.

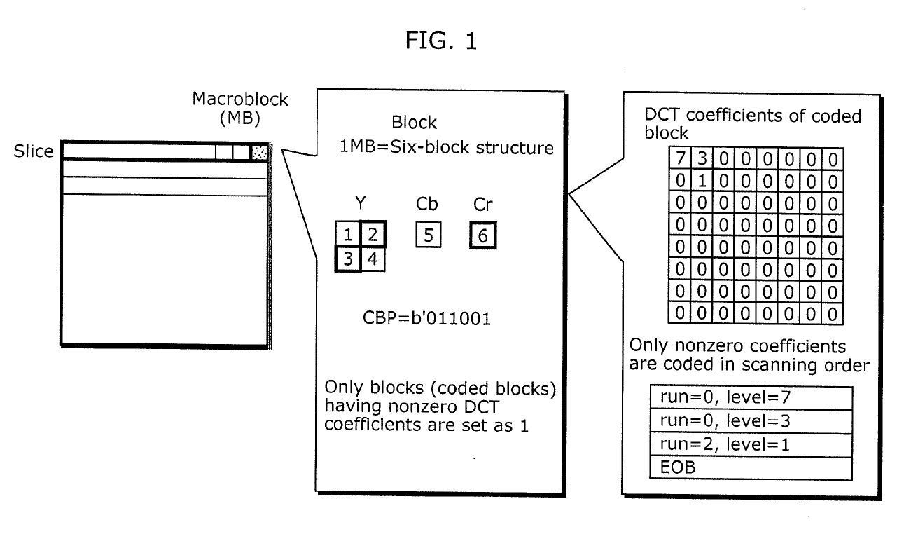

The configuration shown in FIG. 19 is almost equivalent to the configuration shown in FIG. 1, and has the effect of slightly simplifying the configuration.

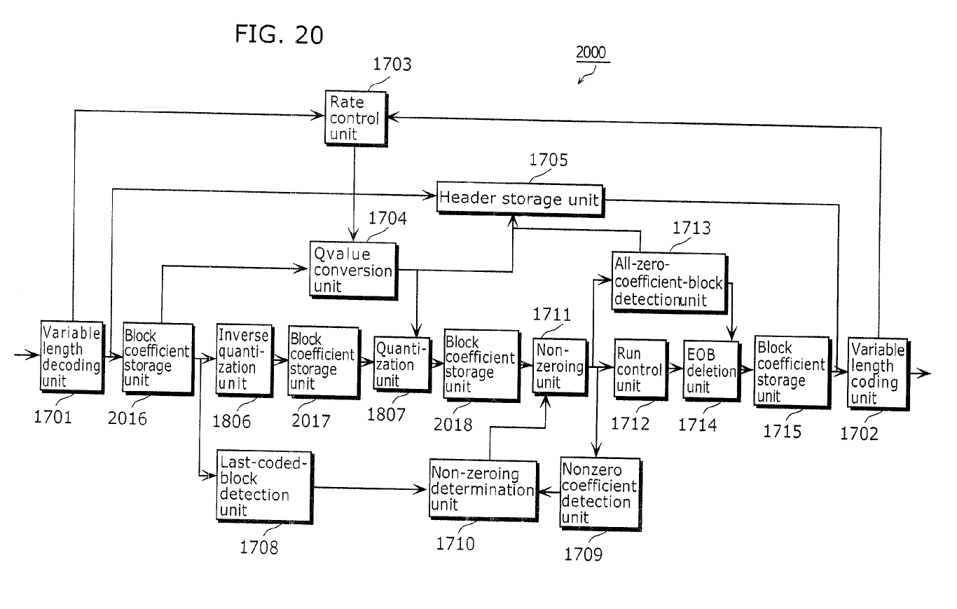

In a coding rate conversion device 2000 shown in FIG. 20: a block coefficient storage unit 2016 is placed between the variable length decoding unit 1701 and the inverse quantization unit 1806 of the coding rate conversion device 1800 shown in FIG. 18; a block coefficient storage unit 2017 is placed between the inverse quantization unit 1806 and the quantization unit 1807 of the coding rate conversion device 1800; and a block coefficient storage unit 2018 is placed between the quantization unit 1807 and the non-zeroing unit 1711 of the coding rate conversion device 1800.

It should be noted that the coding rate conversion devices 1700, 1800, and 1900 respectively shown in FIGS. 17, 18, and 19 perform the rate conversion on the nonzero quantized DCT coefficients one by one. On the other hand, the coding rate conversion device 2000 shown in FIG. 20 performs the rate conversion on the nonzero quantized DCT coefficients, block by block.

Since common picture decoding devices and common picture coding devices perform the processing block by block, the configuration of the coding rate conversion device 2000 shown in FIG. 20 is useful in that the inverse quantization unit 1806, the quantization unit 1807, and the like can be used.

Although the present invention can realized by any of the configurations shown in FIGS. 17, 18, 19, and 20, the coding rate conversion device 1700 shown in FIG. 17 is preferable for its fine balance between the processing efficiency and the ease of realization. Therefore, an operation performed by the coding rate conversion device is explained hereafter using the configuration of the coding rate conversion device 1700 shown in FIG. 17.

Next, the explanation is given on the operation performed by the coding rate conversion device 1700 according to the present embodiment of the present invention.

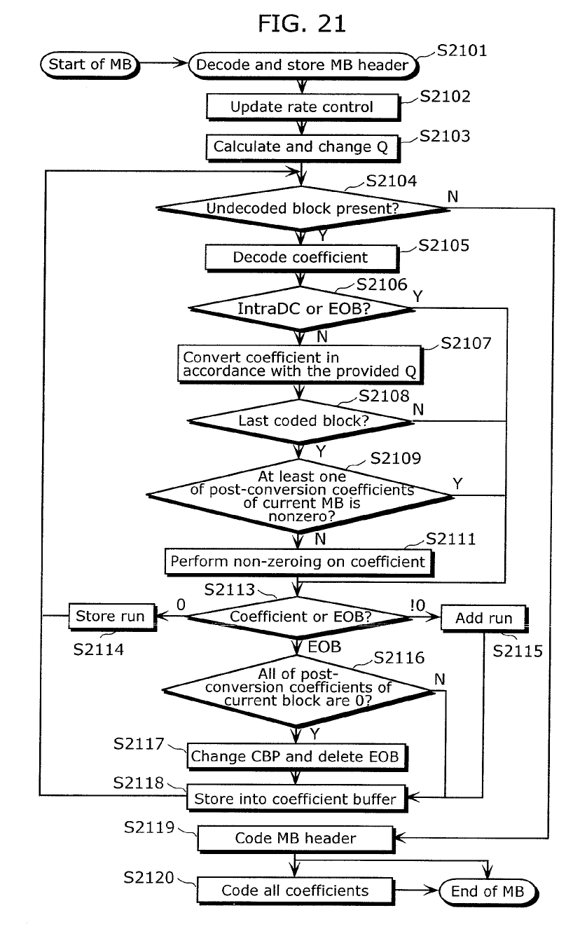

FIG. 21 is a flowchart showing the entire-MB processing performed by the coding rate conversion device 1700, according to the first embodiment of the present invention.

First, the variable length decoding unit 1701 decodes an MB header of an MPEG-2 coded stream, and notifies the header storage unit 1705 of the decoding result. The header storage unit 1705 stores the notified decoding result (S2101).

Also, after the decoding of the MB of the coded stream has completed, the variable length decoding unit 1701 notifies the rate control unit 1703 of the number of bits in the MB of the decoded coded stream.

Next, on the basis of the number of decoded bits and the number of coded bits before the current macroblock, the rate control unit 1703 updates an internal rate control buffer and calculates a target quantization step (S2102). More specifically, on the basis of the actual coding rate calculated from the number of decoded bits of the MB obtained so far by the variable length decoding unit 1701 and the number of coded bits of the MB obtained so far by the variable length coding unit 1702, the rate control unit 1703 calculates the target quantization step. Then, the rate control unit 1703 notifies the Q value conversion unit 1704 of the calculated target quantization step.

Here, in the case of the coding device, the value of this target quantization step can be used as it is, as the quantization step to be used at the time of output. However, this is not always advisable in the case of the rate conversion device. For example, when a small quantization step is assigned to an MB for which a large quantization step is designated at the time of input, it is obvious that the output stream cannot be superior in picture quality to the input stream.

On this account, instead of using the target quantization step as it is as the quantization step at the time of output, the rate conversion device calculates the quantization step to be used at the of output by reference to the quantization step at the time of input as well.

Next, the Q value conversion unit 1704 calculates the quantization step to be used at the time of output from the quantization step at the time of input and the target quantization step received from the rate control unit 1703. The Q value conversion unit 1704 notifies the coefficient conversion unit 1707 and the header storage unit 1705 of the calculated new quantization step. In accordance with this notification, the header storage unit 1705 rewrites the stored quantization scale code (S2103).

Then, the variable length decoding unit 1701 checks the number of decoded blocks by reference to the CBP of the MB header part decoded in S2101 (S2104).

Here, when the MB type is “Not Coded” as the result of the reference to the CBP (N in S2104), this means that no quantization DCT coefficients exist and thus the rate conversion processing for the current MB is terminated. Then, the MB header is re-coded (S2119), and the processing for the MB is terminated. To be more specific, when the MB type is “Not Coded”, the variable length decoding unit 1701 notifies the variable length coding unit 1702 of the parameters of the MB block part of the decoded coded stream, through (passing through) the coefficient conversion unit 1707, the non-zeroing unit 1711, the run control unit 1712, the EOB deletion unit 1714, and the block coefficient storage unit 1715. The variable length coding unit 1702 re-codes the parameters of the MB header part received from the header storage unit 1705 and the parameters of the MB block part received from the variable length decoding unit 1701.

When the MB type is “Coded” or “Intra” as a result of the reference to the CBP, this means that at least one coded block exist. Thus, the processing proceeds to the next step.

Next, the variable length decoding unit 1701 decodes the quantized DCT coefficients one by one (S2105).

When the quantized DCT coefficient is “IntraDC” or “EOB” (Y in S2106), this decoded quantized DCT coefficient is not an object of the coefficient conversion performed by the coefficient conversion unit 1707. In this case, the rate conversion processing for the current MB is terminated, the MB header is re-coded (S2119), and the processing for the MB is terminated, as in the case of N in S2104.

Otherwise, that is, when the quantized DCT coefficient is neither “IntraDC” nor “EOB” (N in S2106), the coefficient conversion unit 1707 performs the coefficient conversion on the quantized DCT coefficient in accordance with the change in the quantization step (S2107).

Here, it is determined whether or not the non-zeroing processing needs to be performed on the converted quantized DCT coefficient. To be more specific, the last-coded-block detection unit 1708 first determines whether or not the block which is the current object of the conversion processing is the last coded block having the nonzero quantized DCT coefficient out of the coded blocks (the CBP), by reference to the CBP of the MB header part decoded by the variable length decoding unit 1701 (S2108).

Next, the nonzero coefficient detection unit 1709 determines whether or not the post-conversion quantized DCT coefficients of the MB which is the current object of the conversion processing include at least one nonzero coefficient (S2109).

In the case where the non-zeroing determination unit 1710 determines Y in S2108 and N in S2109, only when the post-conversion value is 0, the non-zeroing unit 1711 changes the value to a nonzero value such as “1” (S2111). Here, this processing is performed in order to avoid, without performing the backtracking processing, the possibility of a violation of the MPEG-2 standard that all of the quantized DCT coefficients of the MB which is the object of the conversion processing are converted into 0.

Next, the run control unit 1712 receives the quantized DCT coefficient converted by the coefficient conversion unit 1707, through the non-zeroing unit 1711.

When the received quantized DCT coefficient is 0, the run control unit 1712 expresses this coefficient as the run of the next quantized DCT coefficient so that this received coefficient is not coded by the variable length coding unit 1702 as an independent quantized DCT coefficient.

When the received post-conversion quantized DCT coefficient is 0 (0 in S2113), the run control unit 1712 performs processing for storing the run in order to reflect this coefficient in the next quantized DCT coefficient (S2114), so that the coefficient does not become an object of the coding in the variable length coding unit 1702.

Moreover, when the received post-conversion quantized DCT coefficient is a value other than 0 (!0 in S2113), the run control unit 1712 causes the value to be an object of the coding as it is. At this time, when the run is stored in S2114, the run control unit 1712 performs run-addition processing so as to reflect the stored run (S2115).

Then, when receiving the next nonzero quantized DCT coefficient, the run control unit 1712 notifies the block coefficient storage unit 1715 of the run to which only the number of quantized DCT coefficient which had been converted into 0 and were thus deleted is added. The block coefficient storage unit 1715 stores the notified run into a coefficient buffer (S2118).

From the post-conversion quantized DCT coefficients received by the run control unit 1712, the all-zero-coefficient-block detection unit 1713 detects whether or not the EOB is reached without a nonzero quantized coefficient in the block.

When detecting that all the quantized DCT coefficients of the current block are 0, that is, when the EOB is reached without a nonzero quantized coefficient in the block of the MB which is the object of the re-coding processing (EOB in S2113), the all-zero-coefficient-block detection unit 1713 notifies the EOB deletion unit 1714 to delete the EOB. At the same time, the all-zero-coefficient-block detection unit 1713 notifies the header storage unit 1705 to change the CBP of the MB header part included in this block.

On the basis of the notification from the all-zero-coefficient-block detection unit 1713, the header storage unit 1705 changes the CBP of the MB header part and the EOB deletion unit 1714 deletes the EOB which is the end of this block (S2117).

Here, this processing is performed in order to avoid, without performing the backtracking processing, the possibility of a violation of the MPEG-2 standard that all of the quantized DCT coefficients of the MB which is the object of the conversion processing are converted into 0. By this processing, the block in which all of the quantized DCT coefficients become 0 after the coefficient conversion is removed from the coding and the CBP is changed to adhere the MPEG-2 standard.

Next, the block coefficient storage unit 1715 stored the run notified through the EOB deletion unit 1714 into the coefficient buffer, as the quantized DCT coefficient to be coded by the variable length coding unit 1702 (S2118), and proceeds to the processing for the next coefficient (S2104).

When the decoding of all the blocks which are to be coded by the variable length coding unit 1702 has completed after the repetition of the above-described processing from S2104 to S2118 (N in S2104), the value of the CBP in the MB header is finalized. On the basis of the finalized value of the CBP, the contents of the header storage unit 1705 are coded by the variable length coding unit 1702 (S2119).

Finally, the quantized DCT coefficients of one macroblock stored in the block coefficient storage unit 1715 are coded by the variable length coding unit 1702 (S2120).

Accordingly, the variable length coding unit 1702 obtains the streams of the MB header part and the MB block part.

In this way, the coding rate conversion device 1700 performs the entire-MB processing.

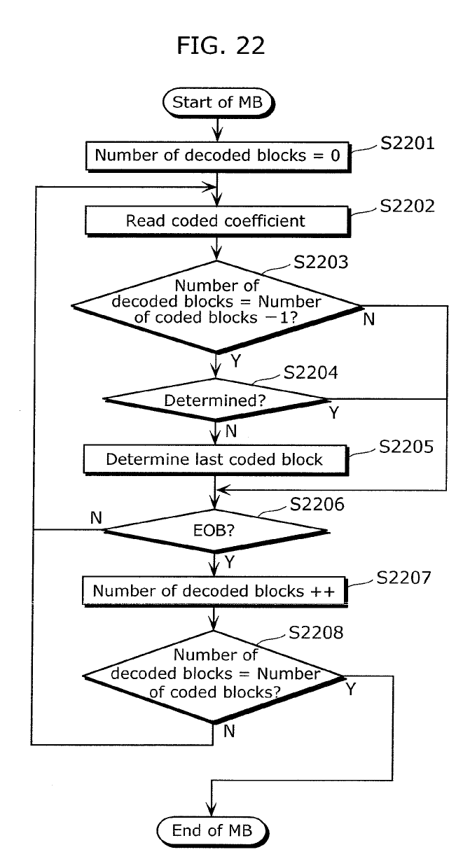

FIG. 22 is a flowchart showing last-coded-block determination processing performed by the coding rate conversion device 1700, according to the first embodiment of the present invention. With reference to FIG. 22, a detailed explanation is given on the last-coded-block determination processing (S2108) performed by the last-coded-block detection unit 1708 of the coding rate conversion device 1700.

First, the last-coded-block detection unit 1708 initializes the number of decoded blocks to 0 at the starting position of the MB received from the variable length decoding unit 1701 (S2201).

Next, the last-coded-block detection unit 1708 reads one of the quantized DCT coefficients obtained from the MB received from the variable length decoding unit 1701 (S2202).

Then, the last-coded-block detection unit 1708 compares: the number of decoded blocks which have been decoded by the variable length decoding unit 1701 and are to be converted by the coefficient conversion unit 1707; and the number (the total number) of coded blocks of the MB indicated by the CBP. When the current number of decoded blocks having been decoded by the variable length decoding unit 1701 is smaller by 1 than the total number of coded blocks of the MB (Y in S2203), the last-coded-block detection unit 1708 determines that the quantized DCT coefficient which is currently being decoded and is to be converted by the coefficient conversion unit 1707 belongs to the last coded block, out of the coded blocks (the CBP), having the nonzero quantized DCT coefficient.

In the present case, the last-coded-block detection unit 1708 determines whether or not it is the last coded block, out of the coded blocks (the CBP), having the nonzero quantized DCT coefficient, by checking an initial coefficient (a first coefficient) of the block which can be the last coded block.

Next, the last-coded-block detection unit 1708 determines whether or not the last coded block having the nonzero quantized DCT coefficient has already been determined (S2204).

When the determination has not been made (N in S2204), the last-coded-block detection unit 1708 detects the initial coefficient (the first coefficient) of the block which can be the last coded block and determines this detected initial coefficient (the first coefficient) as the last coded block (S2205). Here, since the determination is made in S2205, the second and subsequent quantized DCT coefficients of the block determined as the last coded block are not determined. In other words, the determinations for the second and subsequent quantized DCT coefficients are skipped.

Next, the last-coded-block detection unit 1708 determines whether or not the quantized DCT coefficient which is being decoded and is received by the last-coded-block detection unit 1708 is the “EOB” (S2206).

When determining that the present quantized DCT coefficient is not the “EOB” (N in S2206), this means that the block still continues. Thus, the last-coded-block detection unit 1708 returns to decode the next quantized DCT coefficient and repeats the processing from S2202.

When determining that the present quantized DCT coefficient is the “EOB” (Y in S2206), the last-coded-block detection unit 1708 increases the current number of decoded blocks by 1 (S2207), and compares the number of decoded blocks increased by 1 with the number (the total number) of coded blocks of the MB indicated by the CBP (S2208).

When the number of decoded blocks increased by 1 agrees with the number of coded blocks (Y in S2208), this means that the decoding of all of the coded blocks included in the MB has completed and thus the last-coded-block detection unit 1708 terminates the processing.

When the number of decoded blocks increased by 1 does not agree with the number of coded blocks (N in S2208), this means that the coded blocks to be decoded still exist. Thus, the last-coded-block detection unit 1708 returns to decode the next quantized DCT coefficient and repeats the processing from S2202.

In this way, the last-coded-block detection unit 1708 performs the last-coded-block determination processing.

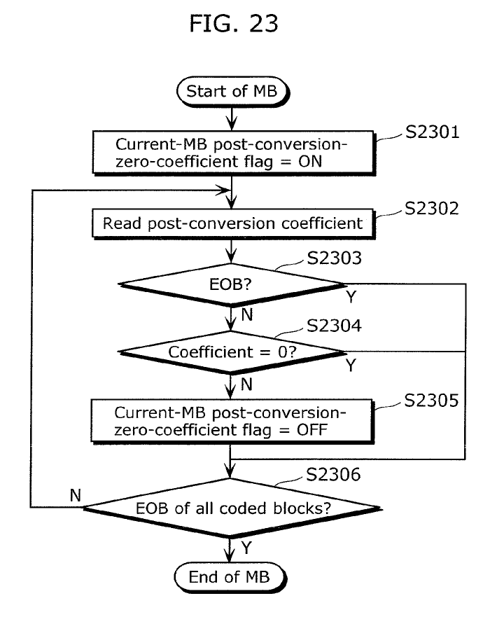

FIG. 23 is a flowchart showing nonzero coefficient detection processing performed by the coding rate conversion device 1700, according to the first embodiment of the present invention. With reference to FIG. 23, a detailed explanation is given on the nonzero coefficient detection processing (S2109) performed by the nonzero coefficient detection unit 1709 of the coding rate conversion device 1700.

First, the nonzero coefficient detection unit 1709 initializes a current-MB post-conversion-zero-coefficient flag to ON at the starting position of the MB provided by the non-zeroing unit 1711 (S2301).

Next, the nonzero coefficient detection unit 1709 reads one of the quantized DCT coefficients received from the variable length decoding unit 1701 and rate-converted by the coefficient conversion unit 1707 (S2302).

When the present quantized DCT coefficient read in S2302 is the “EOB” (Y in S2303), the nonzero coefficient detection unit 1709 detects whether or not the processing has completed for all of the coded blocks of the MB (S2306).

When the processing has not completed for all of the coded blocks of the MB (N in S2306), the processing is continued. When the processing has completed (Y in S2306), the processing for the MB is completed here. It should be noted that the determination as to whether it is the end of the coded block is the same as the processing flow shown in FIG. 22, and thus the detailed explanation is omitted here.

When the quantized DCT coefficient read in S2302 is not the “EOB” (N in S2303), the nonzero coefficient detection unit 1709 detects whether or not the post-rate-conversion quantized DCT coefficient is 0 (S2304).

When the post-rate-conversion quantized DCT coefficient is not 0 (N in S2304), this means that the non-zeroing processing does not need to be performed for the current MB. Thus, the nonzero coefficient detection unit 1709 sets the current-MB post-conversion-zero-coefficient flag to OFF (S2305).

However, when a nonzero coefficient has not occurred in the MB, there is still a possibility that the non-zeroing processing needs to be performed and thus the flag is kept ON in this case.

In this way, the nonzero coefficient detection unit 1709 performs the nonzero coefficient detection processing.

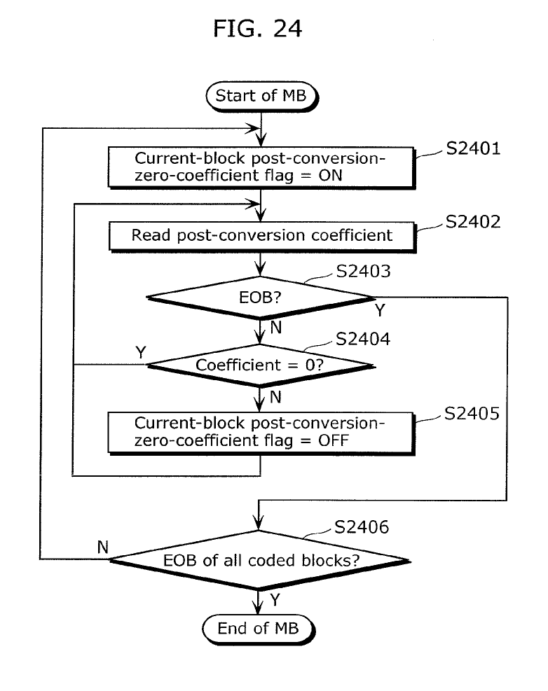

FIG. 24 is a flowchart showing all-zero-coefficient-block detection processing performed by the coding rate conversion device 1700, according to the first embodiment of the present invention. With reference to FIG. 24, a detailed explanation is given on the all-zero-coefficient-block detection processing (S2116) performed by the all-zero-coefficient-block detection unit 1713 of the coding rate conversion device 1700, the all-zero-coefficient-block detection processing being required when the determination as to whether or not the CBP needs to be changed is made.

First, the all-zero-coefficient-block detection unit 1713 initializes a current-block post-conversion-zero-coefficient flag to ON at the starting position of the block of the MB provided by the non-zeroing unit 1711 (S2401).

Next, the all-zero-coefficient-block detection unit 1713 reads one of the quantized DCT coefficients received from the variable length decoding unit 1701 and rate-converted by the coefficient conversion unit 1707 (S2402).

When the present quantized DCT coefficient read in S2402 is the “EOB” (Y in S2403), the all-zero-coefficient-block detection unit 1713 terminates the processing for the current coded block.

When the current-block post-conversion-zero-coefficient flag is OFF at this time, this means that at least one quantized DCT coefficient is nonzero. Thus, the CBP is not changed by the header storage unit 1705. On the other hand, when the current-block post-conversion-zero-coefficient flag is ON at this time, this means that there is no nonzero coefficient. Thus, the header storage unit 1705 changes the value of the corresponding block in the CBP from 1 (coded block) to 0 (all-zero-coefficient block). After this, the processing returns to the initialization of the flag, and the processing of S2401, S2402, and S2403 is performed. When the processing has completed for all of the coded blocks (S2406), the entire-MB processing is terminated.

On the other hand, when the present quantized DCT coefficient read in S2402 is not the “EOB” (N in S2403), the all-zero-coefficient-block detection unit 1713 checks in S2404 whether or not the post-rate-conversion quantized DCT coefficient is 0 (S2404).

When the present quantized DCT coefficient read in S2402 is not 0 (N in S2404), this means that the CBP does not need to be changed. Thus, the all-zero-coefficient-block detection unit 1713 sets the current-block post-conversion-zero-coefficient flag to OFF (S2405), and then returns to the processing of S2402.

However, when a nonzero coefficient has not occurred in the blocks of the MB at the time of S2405, there is still a possibility that the non-zeroing processing needs to be performed. Thus, the all-zero-coefficient-block detection unit 1713 keeps the flag ON in this case.

In this way, the all-zero-coefficient-block detection unit 1713 performs the all-zero-coefficient-block detection processing.

It should be noted that, in the processing flow shown in FIG. 22, the determination made by the last-coded-block detection unit 1708 includes the first-coefficient determination. This is because the processing down to the first-coefficient determination can prevent the second and subsequent quantized DCT coefficients from being determined to be changed to nonzero coefficients. However, even in the case where the first-coefficient determination is not included here, the first coefficient is changed to a nonzero coefficient and the determination made by the nonzero coefficient detection unit 1709 thus changes, so that the second and subsequent quantized DCT coefficients are not to be changed to nonzero coefficients. On account of this, the present processing flow may or may not include the first-coefficient determination.

Next, a concrete operation performed by the coding rate conversion device 1700 of the present invention is explained, with reference to the drawings.

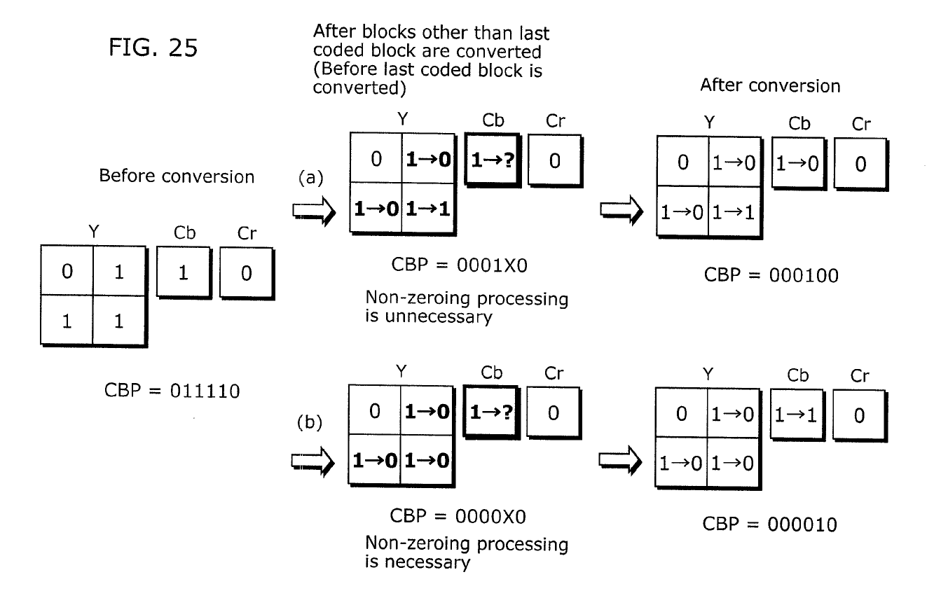

FIGS. 25, 26, 27, and 28 are diagrams showing examples of conversion performed by the coding rate conversion device 1700, according to the first embodiment of the present invention.

FIG. 25 shows examples of cases where the non-zeroing processing does not need to be performed (FIG. 25(a)) and does need to be performed (FIG. 25(b)) for the last coded block.

As shown in FIG. 25, the CBP of the MB which is the object of the rate conversion is 011110 (in binary form). In this case, the last coded block is the fifth block which is a color difference (blue) Cb.

Note that the operation performed for the blocks before the last coded block is the same as the operation performed by the open-loop coding rate conversion device 900, and thus the explanation is omitted here.

The coding rate conversion device 1700 of the present invention employs different conversion methods for the last coded block, depending on a post-conversion state of the block preceding the last coded block (namely, the state immediately before the last coded block is converted).

In FIG. 25(a), the fourth luminance (lower right) has already been finalized as the coded block. The CBP does not become 0 even when the last block, i.e., the fifth color difference (blue) Cb is converted into an all-zero-coefficient block because the CBP of the fourth block is 1 (CBP=0001X0). Therefore, the non-zeroing processing does not need to be performed.

Here, when the non-zeroing processing is not performed, the CBP becomes 000100 as a result, meaning that the CBP does not become 0.

In FIG. 25(b), all the blocks before the last coded block are converted into all-zero-coefficient blocks (CBP=0000X0). Thus, when the last coded block, i.e., the fifth color difference (blue) Cb, is converted into an all-zero-coefficient block, an inconvenience is caused (as CBP=000000). Therefore, the non-zeroing processing is performed.

Here, when the non-zeroing processing is performed, the CBP becomes 000010 as a result, meaning that the CBP does not become 0.

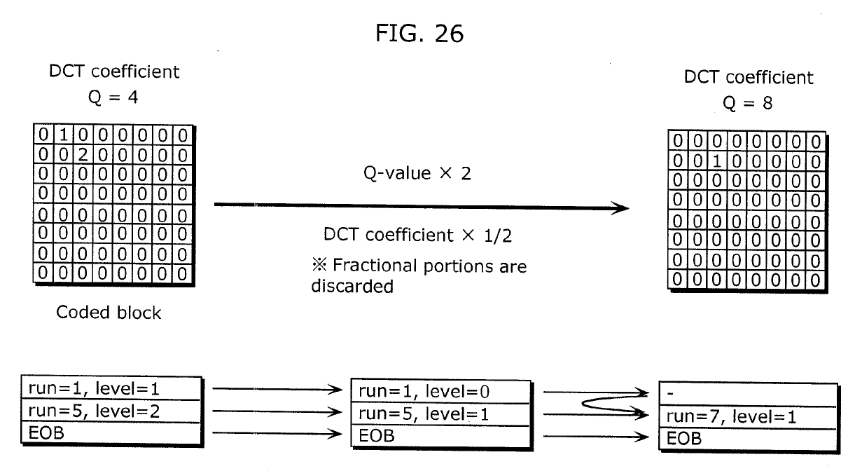

Next, with reference to FIG. 26, an explanation is given on block coefficient conversion processing performed, without the non-zeroing processing, by the coding rate conversion device 1700 of the present invention.

FIG. 26 shows changes in the values of the quantized DCT coefficients and the runs and levels indicating these values in the case where the quantized DCT coefficients having been converted by Q-value=4 are inversely converted and requantized by Q-value=initial-Q-value×2=8. Note that, in the example shown in FIG. 26, the fractional portions of the level values are discarded.

First, the coefficient conversion unit 1707 reads a first quantized DCT coefficient (run=1, level=1) of the coded block and converts the quantized DCT coefficient in accordance with the quantization step (Q-value=8) notified by the Q value conversion unit 1704. The first quantized DCT coefficient (run=1, level=1) is converted to (run=1, level=0).

When level=0, the run control unit 1712 deletes this quantized DCT coefficient (run=1, level=0) (that is, the run control unit 1712 does not notify the block coefficient storage unit 1715 of this quantized DCT coefficient) in order for this quantized DCT coefficient not to be coded. At the same time, the run control unit 1712 stores the run for reflecting the addition in the next quantized DCT coefficient.

In the example shown in FIG. 26, the run of the quantized DCT coefficient to be deleted is 1 and, by the addition of the quantized DCT coefficient to be deleted, the run is increased by 1. As a result, the run to be stored is 1+1=2.

Following this, the coefficient conversion unit 1707 reads the next quantized DCT coefficient (run=5, level=2) of the coded block, and converts the next quantized DCT coefficient (run=5, level=2) into (run=5, level=1) in accordance with the quantization step (Q-value=8) notified by the Q value conversion unit 1704.

In order to reflect the quantized DCT coefficient in the stored run, the run control unit 1712 converts the stored run into: run=5+2=7 (run=7, level=1). Also, the run control unit 1712 notifies the block coefficient storage unit 1715 of the converted quantized DCT coefficient (run=7, level=1) and resets (clears) the stored run to 0.

Finally, the coefficient conversion unit 1707 reads the third coefficient (the EOB) of the block. In this example here, the EOB is stored in the block coefficient storage unit 1715 as it is.

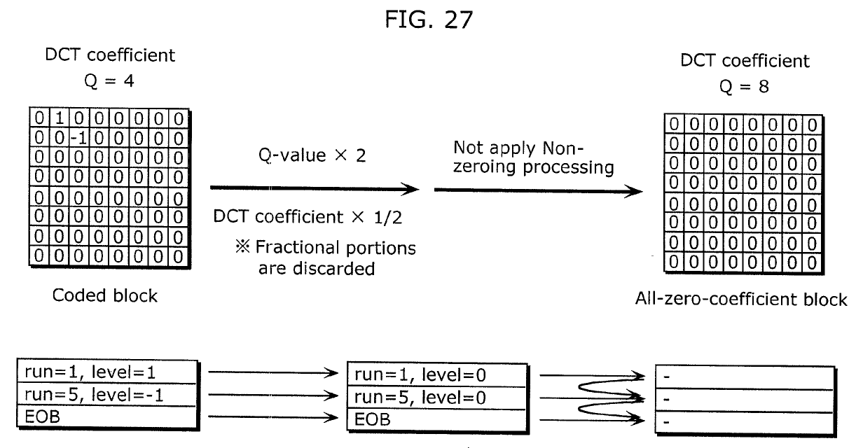

With reference to another example shown in FIG. 27, an explanation is given on the block coefficient conversion processing performed, without the non-zeroing processing, by the coding rate conversion device 1700 of the present invention.

As in the case of FIG. 26, FIG. 27 shows changes in the values of the quantized DCT coefficients and the runs and levels indicating these values in the case where the quantized DCT coefficients having been converted by Q-value=4 are inversely converted and requantized by Q-value=initial-Q-value×2=8. Note that, in the example shown in FIG. 27, the fractional portions of the level values are discarded.

First, the coefficient conversion unit 1707 reads a first quantized DCT coefficient (run=1, level=1) of the coded block, and converts the quantized DCT coefficient into (run=1, level=0) in accordance with the quantization step (Q-value=8) notified by the Q value conversion unit 1704.

Since level=0, the run control unit 1712 stores run=1+1=2 and also deletes this quantized DCT coefficient.

Following this, the coefficient conversion unit 1707 reads the next quantized DCT coefficient (run=5, level=−1) of the coded block, and converts the next quantized DCT coefficient (run=5, level=−1) into the quantized DCT coefficient (run=5, level=0) in accordance with the quantization step (Q−value=8) notified by the Q value conversion unit 1704.

In addition to 2 having already been accumulated, the run control unit 1712 adds run=5 of the quantized DCT coefficients to be deleted and an increase of 1 resulting from the quantized DCT coefficient itself to be deleted. To be more specific, the run control unit 1712 updates the run to be stored to 2+5+1=8, and also deletes the quantized DCT coefficient.

Finally, the coefficient conversion unit 1707 reads the third coefficient (the EOB) of the block.

Here, since the the level of the first coefficient after the conversion is 0 and the level of the second coefficient after the conversion is also 0, the all-zero-coefficient-block detection unit 1713 detects the block as an all-zero-coefficient block.

It should be noted that, when the block is converted into an all-zero-coefficient block, the header storage unit 1705 changes the CBP and the EOB deletion unit 1714 deletes the EOB.

As a result, the block coefficient storage unit 1715 stores no coefficients for the coded block shown as an example in FIG. 27.

In the example shown in FIG. 27, since the non-zeroing processing is not performed, the conversion to an all-zero-coefficient block is performed. In the case where the non-zeroing processing is performed, processing for preventing this all-zero-coefficient-block conversion is performed.

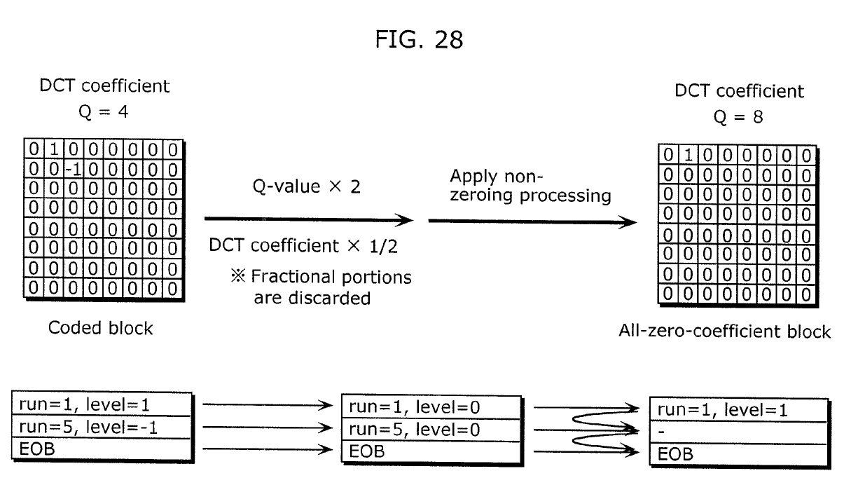

Next, with reference to FIG. 28, an explanation is given on the coefficient conversion processing performed by the coding rate conversion device 1700 of the present invention in the case where the non-zeroing processing is required.

FIG. 28 shows changes in the values of the quantized DCT coefficients and the runs and levels indicating these values in the case where the quantized DCT coefficients having been converted by Q-value=4 are inversely converted and requantized by Q-value=initial-Q-value×2=8. In the example shown in FIG. 28, the non-zeroing processing is applied. Note also that, in the example shown in FIG. 28, the fractional portions of the level values are discarded.

First, the coefficient conversion unit 1707 reads a first quantized DCT coefficient (run=1, level=1) of the coded block, and converts the first quantized DCT coefficient (run=1, level=1) into (run=1, level=0) in accordance with the quantization step (Q−value=8) notified by the Q value conversion unit 1704.

When the level of the first quantized DCT coefficient of the block is 0 in the case where the non-zeroing processing is to be performed, the non-zeroing unit 1711 changes the value to a nonzero value (changes to 1 in this case here). To be more specific, the non-zeroing unit 1711 performs the non-zeroing processing so that the first quantization DCT coefficient after the conversion (run=1, level=0) is converted into (run=1, level=1). Then, the non-zeroing unit 1711 notifies the block coefficient storage unit 1715 that the non-zeroing processing has been performed.

Next, the coefficient conversion unit 1707 reads the next quantized DCT coefficient (run=5, level=−1) of the coded block, and converts the quantized DCT coefficient into (run=5, level=0). Here, this next quantized DCT coefficient is not the first coefficient of the coded block, the non-zeroing unit 1711 does not perform the non-zeroing processing.

Accordingly, since level=0, the run control unit 1712 stores run=5+1 and deletes the quantized DCT coefficient.

Finally, the last coefficient (EOB) of the block is read.

Since the non-zeroing processing is performed on the first coefficient, the all-zero-coefficient-block detection unit 1713 has not detected an all-zero-coefficient block so far. Therefore, the EOB is stored into the block coefficient storage unit 1715 as it is. Also, when the EOB is detected, the run control unit 1712 resets (clears) the stored run.

As explained up to this point with reference to FIGS. 26 to 28, the coefficient conversion processing can be realized in the cases where the non-zeroing processing is required and is not required. Consequently, the coding rate conversion which can avoid the possibility of a violation of the MPEG-2 standard taking place when the MPEG-2 coding rate is converted can be realized.

With this configuration, instead of converting a quantized DCT coefficient to a nonzero coefficient only after detecting that the coded block is to be converted into an all-zero-coefficient block, a prediction that the coded block would be converted into an all-zero-coefficient block is made in advance and the quantized DCT coefficient is thus converted into a nonzero coefficient. Therefore, the backtracking processing does not occur.

Also, with this configuration, not all of the coded blocks are converted into all-zero-coefficient blocks, meaning that the conversion always adhering to the standard can be performed.

Moreover, with this configuration, instead of leaving all the coded blocks as the coded blocks, only the minimum necessary coded blocks are left, so that the rate conversion can be performed with efficiency.

It should be noted that although the present example has been described on the precondition that the MPEG-2 standard is employed, the same discussion can be made in the case of the MPEG-1 standard. Also, when the CBP is changed from a nonzero value to 0 in the case of a picture CODEC employing the standard other than the MPEG-1 and -2, the same discussion can be made when complicated processing is caused.

Furthermore, although the present example has been described on the precondition that a picture CODEC using the DCT transformation is employed, the same discussion can be made in the case where orthogonal transformation other than the DCT transformation is used.

Also, although the present example has been described on the precondition that a picture CODED using blocks in 8-by-8 size is employed, the same discussion can be made in the case where blocks are of a different size.

Moreover, although the present example has been described on the precondition that a picture CODED using a six-block structure represented by 4:2:0 (luminance, color difference, color difference) is employed, the same discussion can be made in the case of a picture CODEC employing a different block structure such as 4:2:2.

Furthermore, although the present example has been described on the precondition that the fractional portions are discarded when the coefficient conversion is performed, the same discussion can be made in the case where the value is rounded off to the nearest integer or the value is changed into the nearest integer using a different method.

### Second Embodiment

When the coding rate conversion device 1700 of the first embodiment is used, a quantized DCT coefficient, which is supposed to be converted into 0 in the case where the non-zeroing processing is not performed, is converted into a nonzero value by the non-zeroing processing. In this case, the conversion into 0 that is supposed to be performed is prevented by the non-zeroing processing, and this may increase an error caused in the coding rate conversion.

Using the method of the first embodiment, the error occurs to the last coded block. Since the luminance block and the color difference blocks are coded in this order according to the MPEG-2 standard, it is more likely that the error occurs to the color differences. Based on the visual feature that human eyes are more sensitive to luminance than color differences, it is not a problem that the error is more likely to occur to the color differences than to the luminance. However, according to the MPEG-2 standard, the coding is performed using the 4:2:0 standard (the six-block structure where the color difference information is one quarter of the luminance information in amount), meaning that the information of the color differences is already reduced. This is to say, the error ends up being added to the color difference information which is already reduced in amount.

Hence, it is likely the case that the color differences are considerably affected by the error as compared with the luminance which has more amount of information. With this being the situation, it is desired that the error caused by the non-zeroing processing should occur only to the luminance to the extent possible. In the second embodiment of the present invention, an explanation is given about a coding rate conversion device 2900 which responds to the need that the error caused by the non-zeroing processing should occur only to the luminance to the extent possible.

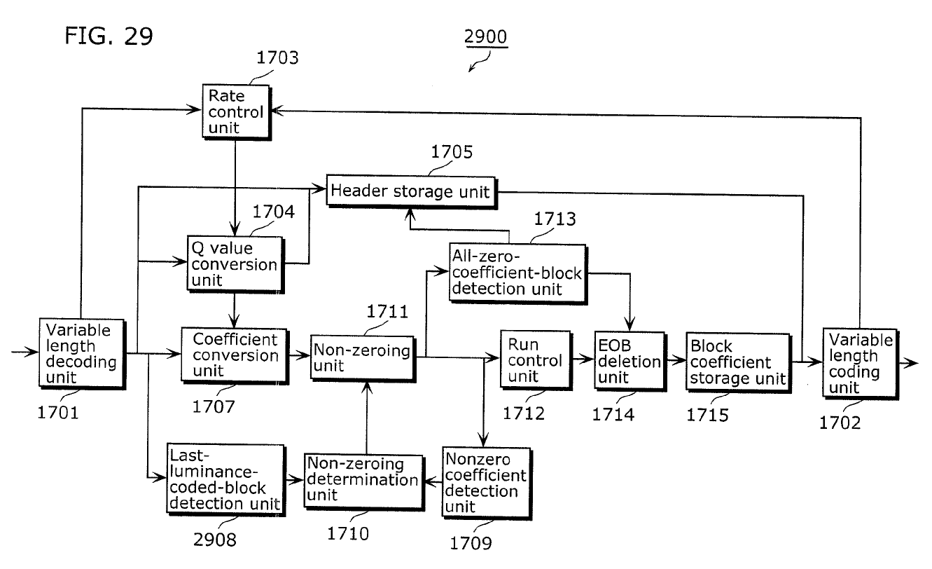

FIG. 29 is a diagram showing a configuration of the coding rate conversion device 2900 according to the second embodiment of the present invention.

In the configuration of the coding rate conversion device 2900 shown in FIG. 29 as compared with the coding rate conversion device 1700 shown in FIG. 17, the last-coded-block detection unit 1708 is replaced with a last-luminance-coded-block detection unit 2908. Note that components common to those in FIG. 17 and FIG. 29 are assigned the same numerals used in FIG. 17, and thus the explanations about the common components are omitted here.

The last-luminance-coded-block detection unit 2908 receives the CBP and the block information from the variable length decoding unit 1701.

From the received CBP and the received block information, the last-luminance-coded-block detection unit 2908 detects the last block, out of the blocks belonging to the luminance of the coded blocks (the CBP), that has a nonzero DCT coefficient and also detects the first quantized DCT coefficient out of the quantized DCT coefficients included in this last block.

The last-luminance-coded-block detection unit 2908 notifies the non-zeroing determination unit 1710 of the detection result.

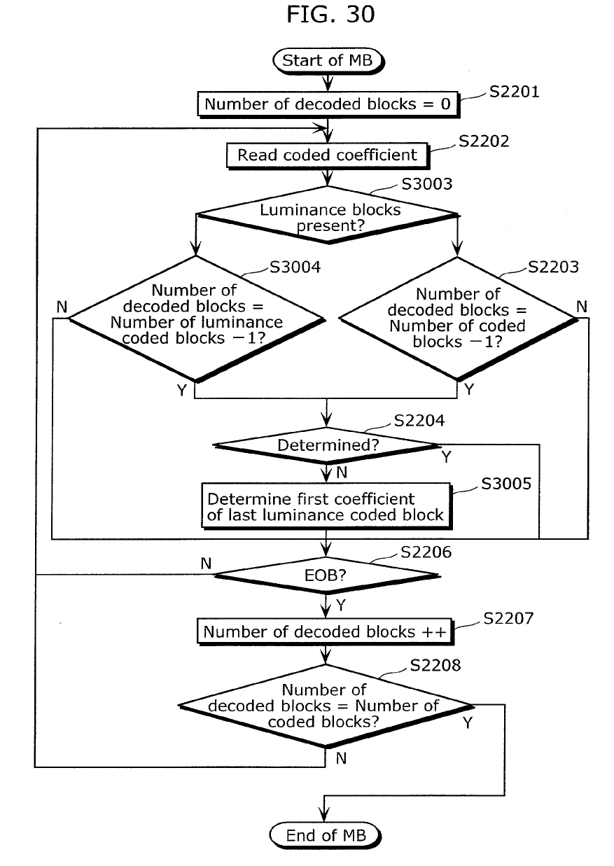

FIG. 30 is a flowchart showing last-luminance-block determination processing performed by the coding rate conversion device 2900, according to the second embodiment of the present invention. In FIG. 30, the processes which are the same as those in the processing flow shown in FIG. 22 are assigned the same numerals used in FIG. 22.

As compared with the processing flow shown in FIG. 22 according to the first embodiment of the present invention, processes S3003 and S3004 are added and S3005 replaces S2205 of FIG. 22.

In S3003, the last-luminance-coded-block detection unit 2908 determines whether or not the coded blocks include the luminance blocks.

When the coded blocks include the luminance blocks (Y in S3003), the last-luminance-coded-block detection unit 2908 compares the number of luminance coded blocks and the number of decoded blocks to determine whether or not the current block is the last luminance coded block (S3004).

To be more specific, the last-luminance-coded-block detection unit 2908 compares: the number of decoded blocks which have been decoded by the variable length decoding unit 1701 and are to be converted by the coefficient conversion unit 1707; and the number of luminance coded blocks indicated by the CBP. When the current number of decoded blocks having been decoded by the variable length decoding unit 1701 is smaller by 1 than the total number of luminance coded blocks (Y in S3004), the last-luminance-coded-block detection unit 2908 determines that the quantized DCT coefficient which is currently being decoded and is to be converted by the coefficient conversion unit 1707 belongs to the last coded block, out of the luminance coded blocks (the CBP), that has the nonzero quantized DCT coefficient.

When determining in S3003 that the coded blocks do not include the luminance blocks, the last-luminance-coded-block detection unit 2908 proceeds to S2203 and makes the same determination as in the first embodiment.

The rest of the processing flow is the same as in FIG. 22, and thus the detailed explanation is omitted here.

It should be noted that, in S3005, the last-luminance-coded-block detection unit 2908 detects an initial coefficient (a first coefficient) of a luminance block which can be the last luminance coded block, and determines it is the last luminance coded block by checking the detected initial coefficient (the first coefficient).

A nonzero coefficient detection flow of the coding rate conversion device 2900 according to the second embodiment of the present invention is the same as S2301 to S2306 shown in FIG. 23 of the first embodiment. Thus, the flow is not shown and the detailed explanation is omitted here.

An all-zero-coefficient-block detection flow of the coding rate conversion device 2900 according to the second embodiment of the present invention is the same as S2401 to S2406 shown in FIG. 24 of the first embodiment. Thus, the flow is not shown and the detailed explanation is omitted here.

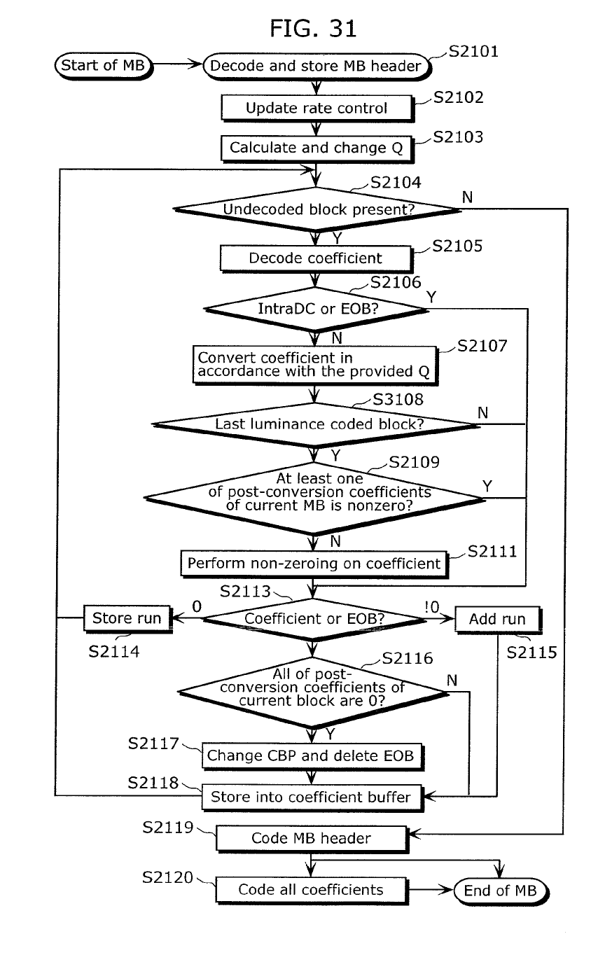

FIG. 31 is a flowchart showing entire-MB processing performed by the coding rate conversion device 2900, according to the second embodiment of the present invention. In FIG. 31, the processes which are the same as those in the processing flow shown in FIG. 21 are assigned the same numerals used in FIG. 21.

As compared with the processing flow of FIG. 21 in the first embodiment of the present invention, S3108 of FIG. 31 replaces S2108 of FIG. 21.

In S3108, when determining that the luminance blocks are included in the coded blocks by reference to the CBP of the MB header part decoded by the variable length decoding unit 1701, the last-luminance-coded-block detection unit 2908 determines whether or not the luminance block which is the current object of the conversion processing is the last luminance block, out of the luminance coded blocks (the CBP), having the nonzero quantized DCT coefficient (S3108).

The rest of the processing flow is the same as in FIG. 21, and thus the detailed explanation is omitted here.

Next, a concrete operation performed by the coding rate conversion device 2900 according to the second embodiment of the present invention is explained, with reference to the drawing.

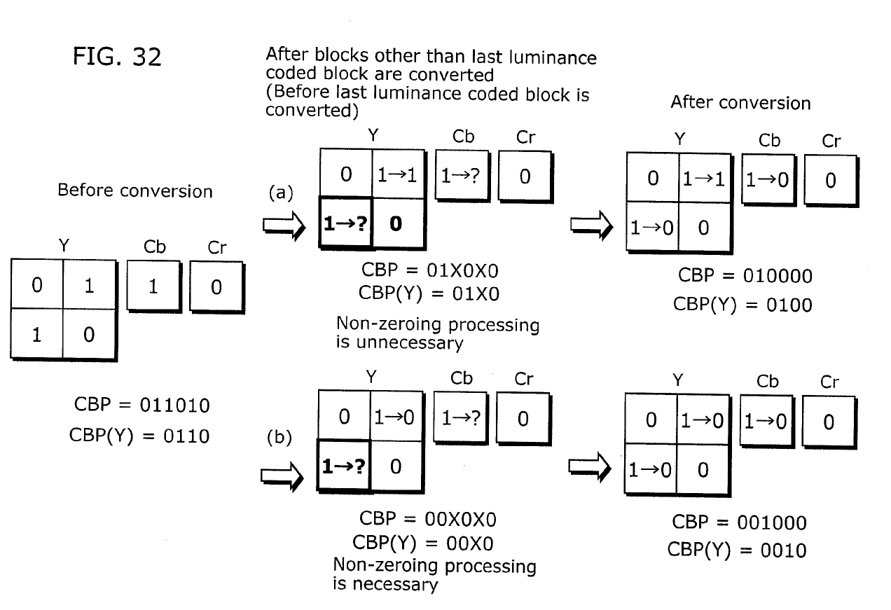

FIG. 32 is a diagram showing examples of conversion performed by the coding rate conversion device 2900, according to the second embodiment of the present invention.

FIG. 32 shows examples of cases where the non-zeroing processing does not need to be performed (FIG. 32(a)) and does need to be performed (FIG. 32(b)) for the last luminance coded block.

As shown in FIG. 32, the CBP of the MB which is the object of the rate conversion is 011010 (in binary form). In this case, although the last coded block is the fifth block which is a color difference (blue) Cb, the last luminance coded block is the third luminance block (lower left).

Note that the operation performed for the blocks before the last luminance coded block (namely, the first and second blocks) is the same as the operation performed by the open-loop coding rate conversion device 900, and thus the explanation is omitted here.

The coding rate conversion device 2900 employs different conversion methods for the last coded block, depending on a post-conversion state of the block preceding the last luminance coded block (namely, the state immediately before the last luminance coded block is converted).

In FIG. 32(a), the second luminance block (upper right) has already been finalized as the coded block.

In FIG. 32(a), CBP (Y) is 01X0 after the blocks other than the last luminance coded block are converted. Thus, the CBP does not become 0 even when the last luminance coded block is converted into an all-zero-coefficient block because the CBP of the second block is 1 (CBP=01X0X0). Therefore, the non-zeroing processing does not need to be performed.

Here, when the non-zeroing processing is not performed, the CBP becomes 010000 as a result, meaning that the CBP does not become 0.

In FIG. 32(b), all the blocks before the last luminance coded block (which are the first and second blocks of the coded blocks) are converted into all-zero-coefficient blocks (CBP(Y)=00X0). Thus, when the third luminance block, i.e., the last luminance coded block, is converted into an all-zero-coefficient block, there is a possibility of a violation of the standard. Therefore, the non-zeroing processing is performed. In the present example, the non-zeroing processing is performed on the third luminance block, i.e., the last luminance coded block (CBP(Y)=0010).

In this case, since it is determined that the luminance blocks include the coded block having a nonzero quantized DCT coefficient, the non-zeroing processing does not need to be performed on the color difference coded blocks.

Although not shown here, when no luminance blocks exist in such a case where the CBP of the MB which is the object of the rate conversion is 000010 (in binary form), the last coded block is to be the object of the non-zeroing processing and the coefficient conversion is accordingly performed as in the first embodiment.

The coefficient conversion processing performed in the cases where the non-zeroing processing is required and is not required is the same as in the first embodiment, and thus the explanation is omitted here.

With the described configuration, the non-zeroing processing is performed only on the luminance block, so that the reduction in picture quality, which may be caused due to an error resulting from the non-zeroing processing performed on the color difference blocks, can be prevented.

### Third Embodiment

In order to determine whether or not to perform the non-zeroing processing, the coding rate conversion device 1700 of the first embodiment performs the complicated processing such as the specific-coded-block detection and the nonzero coefficient detection (as to whether a nonzero quantized DCT coefficient is included in the post-conversion coefficients).

In the third embodiment of the present invention, an explanation is given as follows about a coding rate conversion device 3300 which responds to a detection method that enables more simple processing.

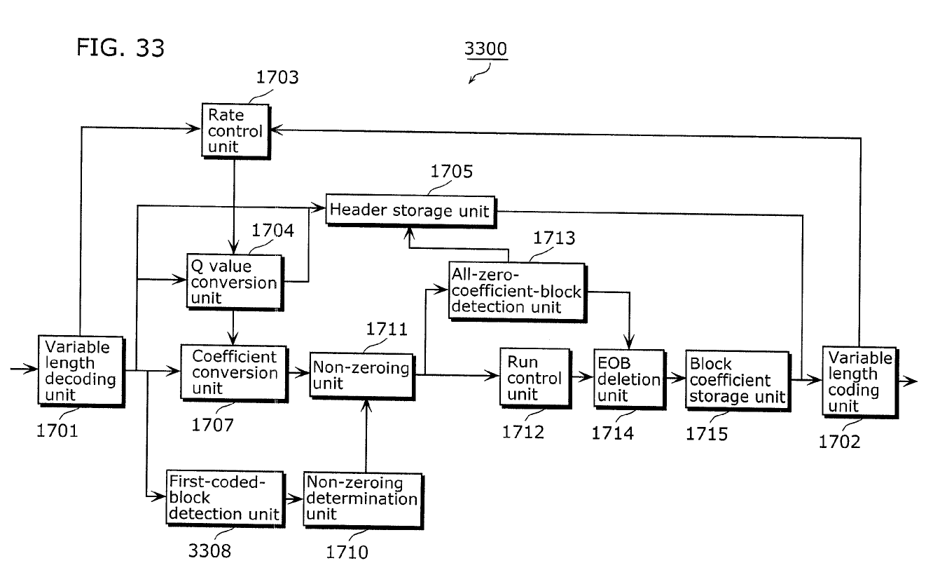

FIG. 33 is a diagram showing a configuration of the coding rate conversion device 3300 according to the third embodiment of the present invention.

In the configuration of the coding rate conversion device 3300 shown in FIG. 33 as compared with the coding rate conversion device 1700 shown in FIG. 17, the last-coded-block detection unit 1708 is replaced with a first-coded-block detection unit 3308 and the nonzero coefficient detection unit 1709 is deleted. Note that components common to those in FIG. 17 and FIG. 33 are assigned the same numerals used in FIG. 17, and thus the explanations about the common components are omitted here.

The first-coded-block detection unit 3308 receives the CBP and the block information from the variable length decoding unit 1701. From the received CBP and the received block information, the first-coded-block detection unit 3308 detects a first quantized DCT coefficient of a macroblock to be coded, and then notifies the non-zeroing unit 1711 of the detection result through the non-zeroing determination unit 1710.

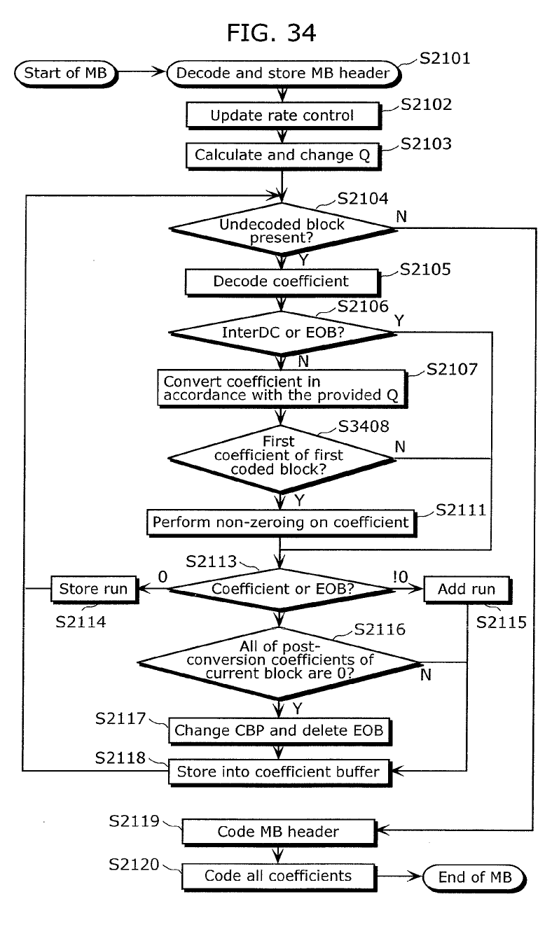

FIG. 34 is a flowchart showing entire-MB processing performed by the coding rate conversion device 3300, according to the third embodiment of the present invention. In FIG. 34, the processes which are the same as those in the processing flow shown in FIG. 21 are assigned the same numerals used in FIG. 21.

As compared with the entire-MB processing flow shown in FIG. 21 according to the first embodiment of the present invention, S2108 of FIG. 21 in which the first coefficient of the last coded block is determined is replaced with S3408 in which a first coefficient of a first coded block is determined, and S2109 in which the determination is made as to whether or not “at least one of post-conversion coefficients of current MB is nonzero” becomes unnecessary.

The rest of the processing flow is the same as in FIG. 21 and thus the detailed explanation is omitted here.

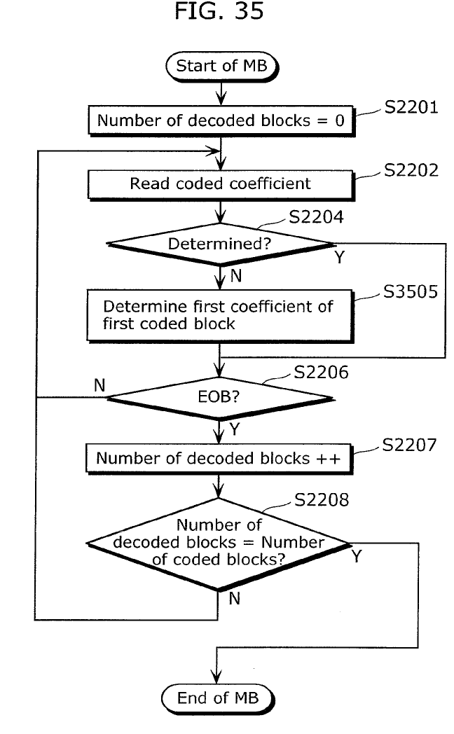

FIG. 35 is a flowchart showing the first-coded-block determination processing performed by the coding rate conversion device 3300, according to the third embodiment of the present invention. In FIG. 35, the processes which are the same as those in the processing flow shown in FIG. 22 are assigned the same numerals used in FIG. 22.

As compared with the processing flow shown in FIG. 22 according to the first embodiment of the present invention, S2203 of FIG. 22 is deleted and S3505 replaces the S2205 of FIG. 22.

FIG. 35 is different from FIG. 22 in that the determination made in S2203 of FIG. 22 as to whether or not “number of decoded blocks=number of coded blocks−1” becomes unnecessary.

In S3505, the first coefficient of the first coded block detected by the first-coded-block detection unit 3308 is a first coefficient after the start of the MB. For this reason, the determination made in S2203 of FIG. 22 to find the position of the quantized DCT coefficient is unnecessary.

The rest of the processing flow is the same as in FIG. 22, and thus the detailed explanation is omitted here.

A nonzero coefficient detection flow of the coding rate conversion device 3300 according to the third embodiment of the present invention is the same as S2301 to S2306 shown in FIG. 23 of the first embodiment. Thus, the flow is not shown and the detailed explanation is omitted here.

An all-zero-coefficient-block detection flow of the coding rate conversion device 3300 according to the third embodiment of the present invention is the same as S2401 to S2406 shown in FIG. 24 of the first embodiment. Thus, the flow is not shown and the detailed explanation is omitted here.

Next, a concrete operation performed by the coding rate conversion device 3300 according to the third embodiment of the present invention is explained, with reference to the drawing.

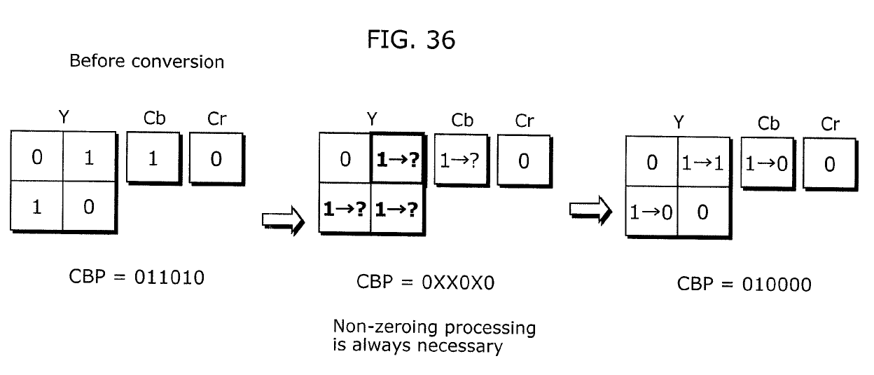

FIG. 36 is a diagram showing an example of conversion performed by the coding rate conversion device 3300, according to the third embodiment of the present invention.

FIG. 36 shows a case where the non-zeroing processing needs to be performed on the first coded block.

As shown in FIG. 36, the CBP of the MB which is the object of the rate conversion is 011010 (in binary form). In this case, although the last coded block is the fifth block which is a color difference (blue) Cb, the first coded block is the second block which is a luminance Y (upper right).

In FIG. 36, the coding rate conversion device 3300 performs the non-zeroing processing on the first coded block (i.e., the second block in FIG. 36).

In the example shown in FIG. 36, a block before the first coded block (i.e., the first block in FIG. 36) is an all-zero-coefficient block. At this point, X parts of CBP=0XX0X are to be converted into all-zero-coefficient blocks and, thus, there is a possibility of a violation of the standard. In the example of FIG. 36, the non-zeroing processing always performed on the first coded block ensures CBP=010000, thereby avoiding the possibility of a violation of the standard.

Here, since the first coded block is finalized as the coded block, the non-zeroing processing does not need to be performed on the second and subsequent coded blocks. This is because, even when all of the remaining blocks are converted into all-zero-coefficient blocks, the CBP will never become 0.

The coefficient conversion processing performed in the cases where the non-zeroing processing is required and is not required is the same as in the first embodiment, and thus the explanation is omitted here.

With the described configuration, by fixing the coded block which is the object of the non-zeroing processing as the first coded block, the processing to determine the object block can be simplified. Moreover, since the detection as to whether or not the post-conversion quantized DCT coefficient is nonzero becomes unnecessary, the configuration can be further simplified as compared with the coding rate conversion device 1700 of the first embodiment.

### Fourth Embodiment

In the case of the coding rate conversion device 1700 of the first embodiment, a nonzero coefficient is fixed as 1 when the non-zeroing processing is performed. On this account, when a quantized DCT coefficient is a negative value before the coefficient conversion unit 1707 performs the coefficient conversion, it can be considered that an error caused by the non-zeroing processing is increased.

In the fourth embodiment of the present invention, an explanation is given as follows about a coding rate conversion device 3700 which reduces the error caused by the non-zeroing processing. For the reduction, the value of the pre-conversion quantized DCT coefficient is considered.

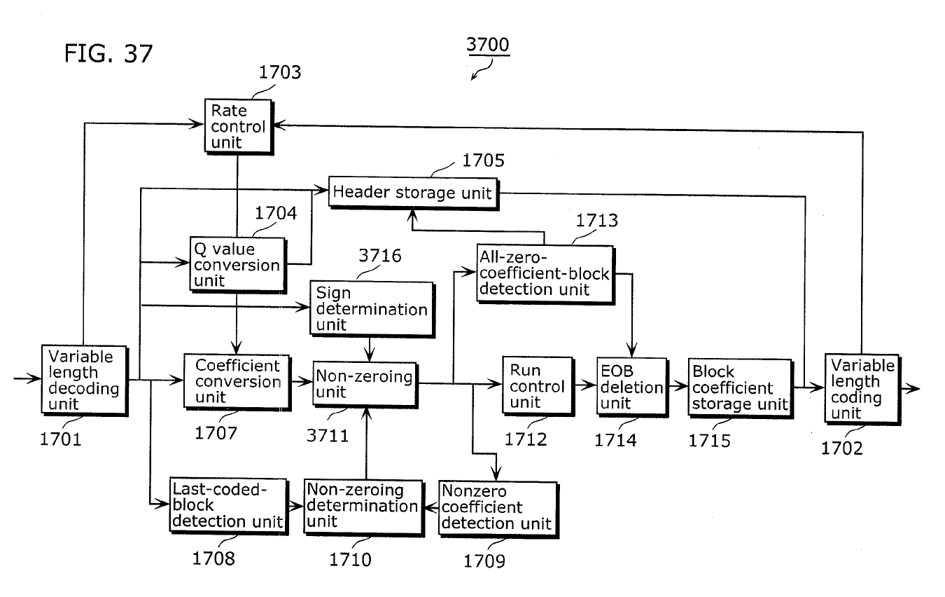

FIG. 37 is a diagram showing a configuration of the coding rate conversion device 3700 according to the fourth embodiment of the present invention.

In the configuration of the coding rate conversion device 3700 shown in FIG. 37 as compared with the coding rate conversion device 1700 shown in FIG. 17, a sign determination unit 3716 is added and the non-zeroing unit 1711 of FIG. 17 is replaced with a non-zeroing unit 3711. Note that, however, components common to those in FIG. 17 and FIG. 37 are assigned the same numerals used in FIG. 17, and thus the explanations about the common components are omitted here.

The sign determination unit 3716 detects a sign of the quantized DCT coefficient which is received from the variable length decoding unit 1701 and has yet to be converted by the coefficient conversion unit 1707, and notifies the non-zeroing unit 3711 of the detected sign.

Here, the processing can be reduced by making the sign determination only for the quantized DCT coefficient on which the non-zeroing processing is to be performed by the non-zeroing unit 3711.

The non-zeroing unit 3711 receives the quantized DCT coefficient which has been requantized by the coefficient conversion unit 1707.

The non-zeroing unit 3711 performs the non-zeroing processing on the received quantized DCT coefficient. When the sign detected by the sign determination unit 3716 is +, the non-zeroing unit 3711 replaces the received quantized DCT coefficient with +1. When the sign detected by the sign determination unit 3716 is −, the non-zeroing unit 3711 replaces the received quantized DCT coefficient with −1.

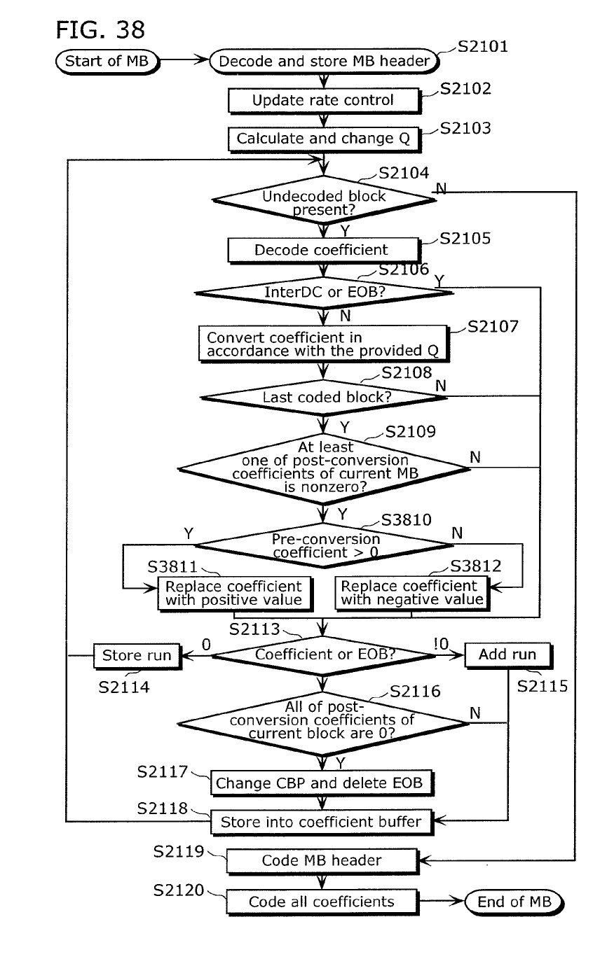

FIG. 38 is a flowchart showing entire-MB processing performed by the coding rate conversion device 3700, according to the fourth embodiment of the present invention. In FIG. 38, the processes which are the same as those in the processing flow shown in FIG. 21 are assigned the same numerals used in FIG. 21.

As compared with the entire-MB processing flow shown in FIG. 21 according to the first embodiment of the present invention, “zeroing of coefficient” performed in S2111 of FIG. 21 is replaced with S3810, S3811, and S3812 in FIG. 38.

In S2109, the nonzero coefficient detection unit 1709 determines whether or not the post-conversion quantized DCT coefficients of the MB which is the current object of the conversion processing include at least one nonzero coefficient.

When the post-conversion quantized DCT coefficients include at least one nonzero coefficient in S2109 and, following this, the non-zeroing processing for the quantized DCT coefficient is determined to be performed, the sign determination unit 3716 detects the sign of the quantized DCT coefficient which is received from the variable length decoding unit 1701 and has yet to be converted by the coefficient conversion unit 1707 (S3810).

When the sign detected by the sign determination unit 3716 is + (Y in S3810), the non-zeroing unit 3711 replaces the coefficient with a positive value such as +1 (S3811).

When the sign detected by the sign determination unit 3716 is −, the non-zeroing unit 3711 replaces the coefficient with a negative value such as −1 (S3812).

The rest of the processing flow is the same as in FIG. 21, and thus the detailed explanation is omitted here.

A last-coded-block determination processing flow of the coding rate conversion device 3700 according to the fourth embodiment of the present invention is the same as shown in FIG. 22 of the first embodiment. Thus, the flow is not shown and the detailed explanation is omitted here.

A nonzero coefficient detection flow of the coding rate conversion device 3700 according to the fourth embodiment of the present invention is the same as shown in FIG. 23 of the first embodiment. Thus, the flow is not shown and the detailed explanation is omitted here.

An all-zero-coefficient-block detection flow of the coding rate conversion device 3700 according to the fourth embodiment of the present invention is the same as shown in FIG. 24 of the first embodiment. Thus, the flow is not shown and the detailed explanation is omitted here.

Next, a concrete operation performed by the coding rate conversion device 3700 according to the fourth embodiment of the present invention is explained as follows, with reference to the drawing. Note that the concrete operation performed by the coding rate conversion device 3700 is the same as the operation performed in the first embodiment, except for the coefficient conversion processing in the case where the non-zeroing processing is required, and thus the explanation is omitted.

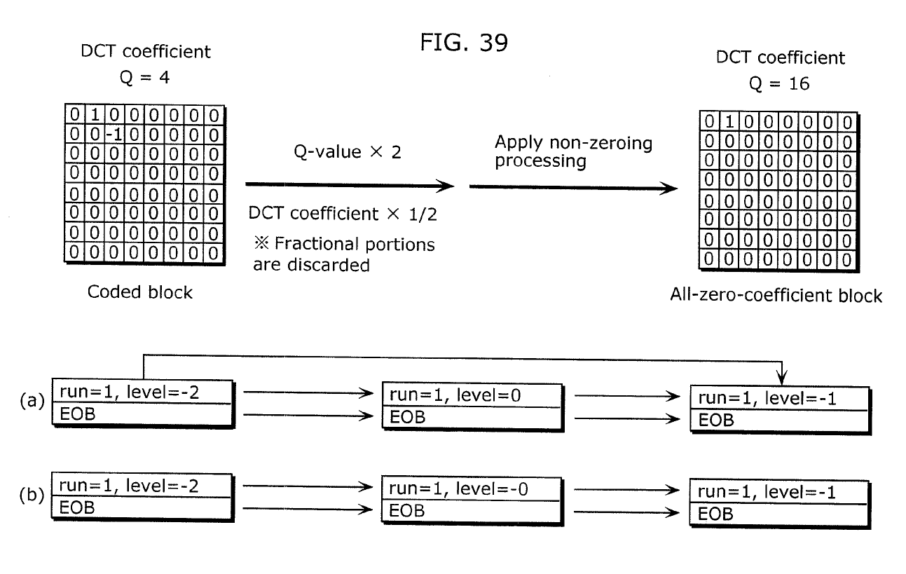

FIG. 39 is a diagram showing an example of conversion performed by the coding rate conversion device 3700, according to the fourth embodiment of the present invention. The coefficient conversion processing performed by the coding rate conversion device 3700 of the present invention in the case where the non-zeroing processing is required is explained with reference to FIG. 39(a).

FIG. 39 shows changes in the values of the quantized DCT coefficients and the runs and levels indicating these values in the case where the quantized DCT coefficients having been converted by Q-value=4 are inversely converted and requantized by Q-value=initial-Q-value×4=16. In the example shown in FIG. 39, the non-zeroing processing is applied. Also note that, in the example shown in FIG. 39, the fractional portions of the level values are discarded.

First, the coefficient conversion unit 1707 reads a first quantized DCT coefficient (run=1, level=−2) of the coded block. Here, when based on the quantization step (Q-value=16: the Q value is converted from 4 into 16 in this case) notified by the Q value conversion unit 1704, the first quantized DCT coefficient (run=1, level=−2) is converted into (run=1, level=−2/4=−0.5). However, since the level is an integer, the coefficient is converted into (run=1, level=0) actually.

In the case where the non-zeroing processing is required and the level of the first quantized DCT coefficient of the coded block is 0, the non-zeroing unit 3711 performs the processing to change the value to a nonzero value.

First, by reference to the level of the quantized DCT coefficient which has yet to be converted by the coefficient conversion unit 1707, the sign determination unit 3716 notifies the non-zeroing unit 3711 of the detected sign. In the present example, the sign determination unit 3716 notifies the non-zeroing unit 3711 of the negative sign.

The non-zeroing unit 3711 uses −1 as a nonzero value. Therefore, an error to be caused in this case is |−1−(−0.5)|−=0.5.

On the other hand, when 1 is fixed as a nonzero value as in the first embodiment, the error to be caused here is |1−(−0.5)|=1.5. It can be seen from the comparison that the error is reduced.

Then, the non-zeroing unit 3711 stores the converted quantized DCT coefficient as (run=1, level=−1) into the block coefficient storage unit 1715.

Next, the coefficient conversion unit 1707 reads the last quantized DCT coefficient (the EOB) of the coded block. At this point, because of the non-zeroing processing performed on the first coefficient, the all-zero-coefficient-block detection unit 1713 does not detect an all-zero-coefficient block. Thus, the EOB is stored into the block coefficient storage unit 1715 as it is.

In the fourth embodiment of the present invention, the sign determination unit 3716 detects a sign from a quantized DCT coefficient which has yet to be converted by the coefficient conversion unit 1707. However, the pre-conversion sign may be retained even when the coefficient conversion unit 1707 converts the quantized DCT coefficient into 0, so that the sign determination unit 3716 can detect the sign from the post-conversion quantized DCT coefficient. The operation performed here is explained with reference to an example shown in FIG. 39(b).

In the example shown in FIG. 39(b), the coefficient conversion unit 1707 first converts the first quantized DCT coefficient (run=1, level=−2) of the coded block into (run=1, level=−0)

Here, by reference to the sign of the level of the quantized DCT coefficient which has yet to be converted by the coefficient conversion unit 1707, the sign determination unit 3716 notifies the non-zeroing unit 3711 of the detected sign. In the present example, the sign determination unit 3716 notifies the non-zeroing unit 3711 of the negative sign.

Then, in consideration of the sign notified by the sign determination unit 3716, the non-zeroing unit 3711 performs the non-zeroing processing so that level=−1.

In the above example, the coefficient conversion unit 1707 adds the sign to 0, and the sign determination unit 3716 provides the notification to the non-zeroing unit 3711 by reference to the sign added to 0. However, in the case where the coefficient conversion unit 1707 adds the sign to 0, the coefficient conversion unit 1707 does not need to exist. More specifically, the same effect can be achieved by a configuration where the non-zeroing unit 3711 performs the non-zeroing processing on only an absolute value and the sign does not need to be changed.

Moreover, as the replacement values in the non-zeroing processing, +1 is used a positive value and −1 is used as a negative value. However, the absolute value does not have to be 1, and thus a different integer may be used as long as the sign is the same as before the conversion.

With the described configuration, the non-zeroing processing is performed in accordance with the sign of the quantized DCT coefficient which has yet to be converted by the coefficient conversion unit 1707, so that the error which may be caused by the non-zeroing processing is reduced. Accordingly, the picture quality is expected to be improved when the coding rate is converted.

### Fifth Embodiment

In the present embodiment, an explanation is given about an application of the coding rate conversion devices described in the first to fourth embodiments and a system which uses the application.

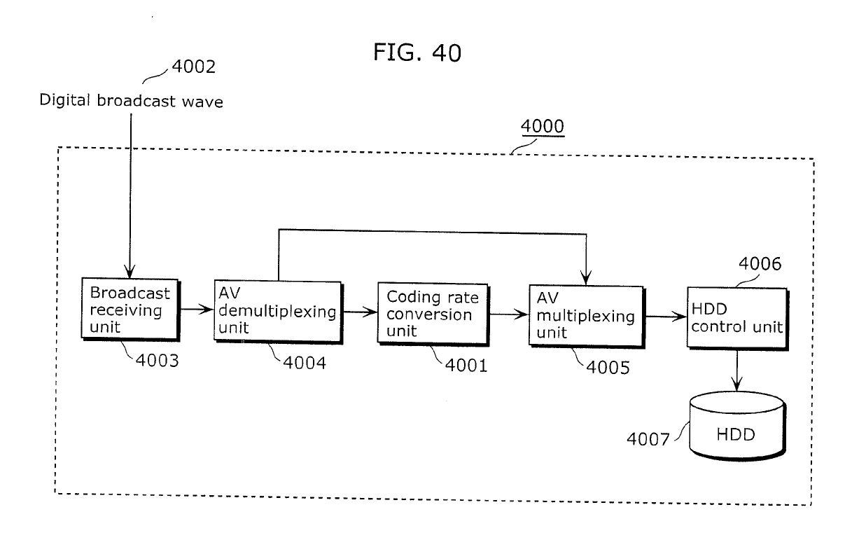

FIG. 40 is a diagram showing a configuration of a stream recording device 4000 according to the fifth embodiment of the present invention. FIG. 40 shows an example of and a system configuration of a broadcast stream recording device using the coding rate conversion device 1700, 1800, 1900, 2000, 2900, 3300, or 3700.

The broadcast stream recording device 4000 includes a coding rate conversion unit 4001, a broadcast receiving unit 4003, an AV demultiplexing unit 4004, an AV multiplexing unit 4005, an HDD control unit 4006, and an HDD 4007.

The broadcast stream recording device 4000 operates when receiving a digital broadcast wave. The broadcast stream recording device 4000 converts a coding rate of digital data received from the broadcast wave, and records the digital data of the converted coding rate into the HDD 4007.

In the digital broadcast wave 4002, picture data coded according to the MPEG-2 standard, audio data coded according to AAC, and system data such as subtitle information and data broadcast are multiplexed to form one program. Moreover, in the digital broadcast wave 4002, a plurality of programs are multiplexed and transmitted on a carrier wave in a modulated state.

The broadcast receiving unit 4003 demodulates the digital broadcast wave 4002 and separates a desired program from the plurality of programs. Then, the broadcast receiving unit 4003 notifies the AV demultiplexing unit 4004 of the program.

From the stream in which the picture data, the audio data, and the system data are multiplexed, the AV demultiplexing unit 4004 extracts only the picture data and notifies the coding rate conversion unit 4001 of the extracted picture data. The AV demultiplexing unit 4004 notifies the AV multiplexing unit 4005 of the stream data except for the picture data.

The coding rate conversion unit 4001 converts the rate of the received picture data into a desired coding rate, and notifies the AV multiplexing unit 4005 of the picture data for which the coding rate has been converted. Here, the coding rate conversion unit 4001 corresponds to the coding rate conversion device 1700, 1800, 1900, 2000, 2900, 3300, or 3700 described in the first to fourth embodiments.

The AV multiplexing unit 4005 multiplexes the picture data for which the coding rate has been converted by the coding rate conversion unit 4001, the original audio data, and the original system data, to reconstruct one program. The AV multiplexing unit 4005 notifies the HDD control unit 4006 of the reconstructed program.

The HDD control unit 4006 records the program notified by the AV multiplexing unit 4005 into the HDD 4007.

Incidentally, the coding rate of the BS digital broadcasting of Japan is 24 Mbps per program. On this account, when a one-hour program is recorded as it is into the HDD, space of 10 Gbytes or more is required. Even when the HDD has 250 Gbytes of space, recording corresponding to only about 20 hours can be performed. For this reason, there is a desire to record more long-hour programs.

On the basis that the picture data occupies about 90% in the program, the broadcast stream recording device 4000 of the fifth embodiment can respond to the above-mentioned desire by converting the coding rate of the picture data in half using the coding rate conversion unit 4001.

In the fifth embodiment, the broadcast stream recording device 4000 receives the digital broadcast wave 4002. However, the broadcast stream recording device 4000 may receive a stream recorded in the HDD 4007 without the coding rate conversion or a stream distributed via a network.

Moreover, although the recording destination of the broadcast stream recording device 4000 is the HDD 4007 in the fifth embodiment, the recording destination may be a different record medium, such as optical discs like a DVD, or a memory card.

### Sixth Embodiment

In the sixth embodiment, an explanation is given about an application of the coding rate conversion devices described in the first to fourth embodiments and a system which uses the application.

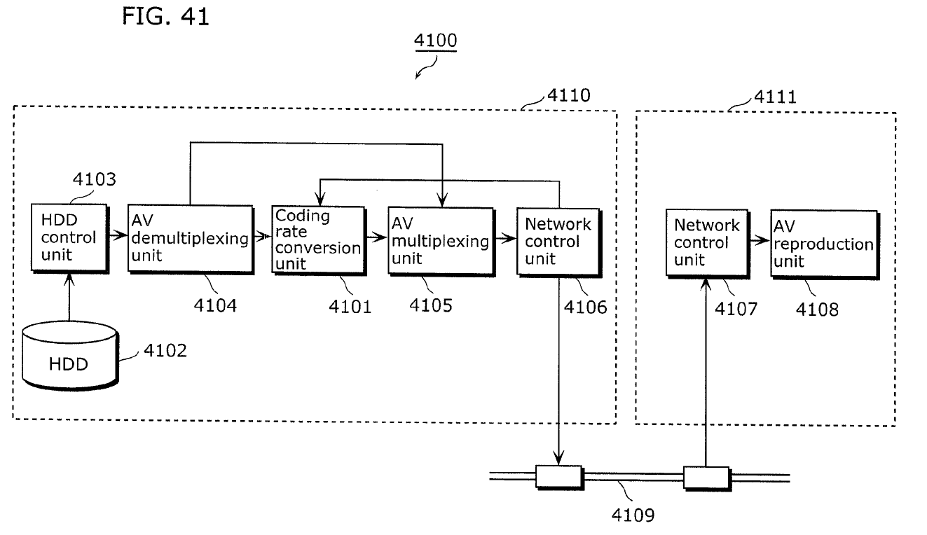

FIG. 41 is a diagram showing a configuration of a network distribution system according to a sixth embodiment of the present invention. FIG. 41 shows a configuration of an example of the network distribution system using the coding rate conversion device 1700, 1800, 1900, 2000, 2900, 3300, or 3700.

The network distribution system 4100 includes a stream sending device 4110 for sending a coded stream, a stream receiving device 4111 for receiving the coded stream, and a network 4109 for transmitting the coded stream.

The network distribution system 4100 distributes an AV stream recorded in an HDD 4102 of the stream sending device 4110, via the network 4109, and then reproduces the stream using the stream receiving device 4111.

The stream sending device 4110 includes a coding rate conversion unit 4101, an HDD 4102, an HDD control unit 4103, an AV demultiplexing unit 4104, an AV multiplexing unit 4105, and a network control unit 4106. In the HDD 4102, an AV stream including a picture stream, an audio stream, and a system stream is multiplexed as one program and is stored.

The HDD control unit 4103 reads the AV stream from the HDD 4102, and notifies the AV demultiplexing unit 4104 of the AV stream.

As in the fifth embodiment, the AV demultiplexing unit 4104 separates only the picture stream and notifies the coding rate conversion unit 4101 of the picture stream. The AV demultiplexing unit 4104 notifies the AV multiplexing unit 4105 of the stream except for the picture stream.

The coding rate conversion unit 4101 converts the coding rate of the received picture stream, and notifies the AV multiplexing unit 4105 of the picture stream for which the coding rate has been converted. Here, the coding rate conversion unit 4101 corresponds to the coding rate conversion device 1700, 1800, 1900, 2000, 2900, 3300, or 3700 described in the first to fourth embodiments.

The AV multiplexing unit 4105 re-multiplexes and reconstructs the picture stream for which the coding rate has been converted by the coding rate conversion unit 4101, the audio stream, and the system stream. Then, the AV multiplexing unit 4105 notifies the network control unit 4106 of the reconstructed AV stream.

The network control unit 4106 sends the AV stream received from the AV multiplexing unit 4105 to a network control unit 4107 via the network 4109.

Moreover, the network control unit 4106 detects the coding rate of the AV stream transmittable on the network 4109, and notifies the coding rate conversion unit 4101 of the coding rate.

The stream receiving unit 4111 includes the network control unit 4107 and an AV reproduction unit 4108.

The network control unit 4107 receives the AV stream from the network control unit 4106 via the network 4109. The network control unit 4107 notifies the AV reproduction unit 4108 of the received AV stream.

The AV reproduction unit 4108 performs the AV demultiplexing and the decoding on the AV stream notified by the network control unit 4107, and reproduces the picture (including data broadcasts and subtitles) and the audio.

Note that since the AV reproduction unit 4108 is not directly related to the coding rate conversion, a description of the detailed configuration is omitted here.

Incidentally, the coding rate of the BS digital broadcasting of Japan is 24 Mbps per program. Yet, data other than the AV stream is also being transmitted at the same time on the network. For this reason, in many cases, a band of 24 Mbps is not guaranteed. Moreover, when the network is wireless, the transmittable band changes depending on a reception state, and thus again, the band of 24 Mbps is not guaranteed in many cases. On account of this, when the transmittable band cannot be guaranteed, this may cause dropouts of the AV stream data. Because of the dropouts, errors frequently occur during the stream decoding, and the AV reproduction can be hardly performed.

In the stream sending device 4110, the network control unit 4106 detects the state of the network 4109 and notifies the coding rate conversion unit 4101 of a transmittable band of the network 4109. Then, the coding rate conversion unit 4101 can convert the rate of the AV stream into the coding rate at which the network 4109 can transmit the AV stream. Accordingly, the data dropouts are not caused on the network 4109, so that the stream receiving device 4111 can normally perform the AV reproduction.

In the present embodiment, a sending source of the AV stream is the HDD 4102 of the stream sending device 4110. However, the sending source may be the digital broadcast wave itself or a different record medium.

According to the present invention as described so far, a first quantized DCT coefficient, which is the first in the scanning order, of a specific coded block out of a plurality of blocks in an MB to be coded is guaranteed to be a value other than 0 (a nonzero value). Thus, it becomes allowable that all of the quantized DCT coefficients of the blocks other than the specific coded block may become 0. This means that no backtracking is required in order to perform the non-zeroing processing only after the quantized DCT coefficients of all the blocks in the MB which is the coding object are found to be 0. Moreover, only the first quantized DCT coefficient, which is the first in the scanning order, of the specific coded block out of the plurality of blocks in the MB to be coded is converted into a value other than 0 (a nonzero value). Therefore, for example, even when a nonzero quantized DCT coefficient exists in the block other than the specific coded block and the specific coded block thus has an unnecessary nonzero quantized DCT coefficient, the influence is exerted by only one quantized DCT coefficient. Therefore, the coding rate conversion can be performed without a decrease in coding efficiency.

The present invention as described so far can realize a coding rate conversion device and a coding rate conversion method which avoid the possibility of a violation of the coding standard taking place when the coding rate of the coded stream is converted, without performing the backtracking process and without a decrease in coding efficiency.

The following are the possibilities of a violation of the coding standard taking place when the coding rate of the coded stream is converted.

1) A case where the quantized DCT coefficients of the blocks included in the MB are all 0 after the coding rate conversion:
A coded block which does not have a nonzero quantized DCT coefficient is against the standard.
In such a case, in order to avoid the violation of the standard, the block having no nonzero quantized DCT coefficient is removed from the coding and the CBP needs to be accordingly changed.

2) A case where all the blocks included in the MB are removed from the coding after the coding rate conversion (CBP=0 ):
The coding as CBP=0 is against the standard.
In such a case, in order to avoid the violation of the standard, the macroblock type needs to be changed to “Not Coded”.

3) A case where the macroblock type is “NoMC”:
“NoMC” and “Not Coded” as the macroblock type after the coding rate conversion is against the standard.
In such a case, in order to avoid the violation of the standard, the macroblock needs to be changed into a skip MB.

4) A case where the MB is the first MB or the last MB of a slice:
An MB changed into a skip MB after the coding rate conversion is against the standard.

Additionally, all the functional blocks included in the coding rate conversion device in the embodiments are typically realized as a program to be operated on an information technology device requiring a CPU and a memory. Some or all of these functions may be realized as LSIs which are integrated circuit devices. These LSIs may be integrated into individual chips, or into a single chip so as to include some or all of the LSIs. Although referred to as the LSI here, it may be referred to as an IC, a system LSI, a super LSI, or an ultra LSI depending on the scale of integration.

Moreover, a method for circuit integration is not limited to application of an LSI. It may be realized using a dedicated circuit or a general purpose processor. An FPGA (Field Programmable Gate Array) which is programmable after the manufacture of the LSI, or a reconfigurable processor for which the connections and settings of circuit cells inside the LSI are reconfigurable may be used.

Furthermore, when a circuit integration technology that replaces LSIs comes along owing to advances of the semiconductor technology or to a separate derivative technology, the functional blocks should be understandably integrated using that technology. There can be a possibility of adaptation of biotechnology, for example.

### INDUSTRIAL APPLICABILITY

The present invention can be applied to a coding rate conversion device and a coding rate conversion method. In particular, the present invention can be applied to a coding rate conversion device and a coding rate conversion method whereby a coding rate of a picture stream is decreased in a broadcast stream recording device or a stream sending device which sends the stream to a network.

1. A coding rate conversion device which performs rate conversion on first coded data by inversely quantizing the first coded data having been quantized with a first quantization step and by requantizing the first coded data with a second quantization step larger in step size than the first quantization step, said coding rate conversion device comprising:
a block specifying unit configured to specify an object block which has a nonzero coefficient, out of a plurality of blocks included in the first coded data; and
a non-zeroing unit configured to perform non-zeroing processing by which a first nonzero coefficient of the specified object block becomes a nonzero coefficient even after the rate conversion is performed using the second quantization step, when the rate conversion is performed on the specified object block.

2. The coding rate conversion device according to claim 1, further comprising
a non-zeroing determination unit configured to determine, when the rate conversion is performed on the plurality of blocks included in the first coded data block by block in order of coding, whether or not the rate-converted block has a nonzero coefficient,
wherein said block specifying unit is configured to specify a predetermined block as the object block when each of the plurality of blocks having been rate-converted prior to the predetermined block has no nonzero coefficient as a result of the determination.

3. The coding rate conversion device according to claim 1, comprising
a rate conversion unit configured to perform the rate conversion by requantizing the inversely quantized first coded data with the second quantization step, for each coefficient of the blocks included in the first coded data,
wherein said non-zeroing unit is configured to perform the non-zeroing processing on the first nonzero coefficient of the specified coded block before a next coefficient following the first nonzero coefficient in order of conversion is rate-converted by said rate conversion unit.

4. The coding rate conversion device according to claim 3,
wherein said non-zeroing unit is configured to perform the non-zeroing processing only on the first nonzero coefficient.

5. The coding rate conversion device according to claim 4, wherein said block specifying unit is configured to specify the object block out of the plurality of blocks included in a unit of coding of the first coded data.

6. The coding rate conversion device according to claim 2,
wherein said block specifying unit is configured to specify a last block in order of coding as the object block, out of one or more blocks which are included in a unit of coding and have nonzero coefficients respectively, and
said non-zeroing unit is configured to perform the non-zeroing processing on a first nonzero coefficient of the last coded block when said non-zeroing determination unit determines that each of the blocks prior to the last coded block in order of coding has no nonzero coefficient.

7. The coding rate conversion device according to claim 2,
wherein said block specifying unit is configured to specify a last block in order of coding as the object block, out of luminance component blocks which are included in a unit of coding and have nonzero coefficients respectively, and
said non-zeroing unit is configured to perform the non-zeroing processing on a first nonzero coefficient of the last luminance component block when said non-zeroing determination unit determines that coefficients of each of the luminance component blocks prior to the last luminance component block in order of coding are all zero coefficients.

8. The coding rate conversion device according to claim 1,
wherein said block specifying unit is configured to specify a first block in order of coding as the object block, out of a plurality of blocks which are included in a unit of coding and have nonzero coefficients respectively.

9. The coding rate conversion device according to claim 1,
wherein said non-zeroing unit is configured to change the post-rate-conversion nonzero coefficient, on the basis of a sign of the first nonzero coefficient of the object block specified by said block specifying unit.

10. The coding rate conversion device according to claim 9,
wherein said non-zeroing unit is configured to perform the non-zeroing processing so that: the post-rate-conversion nonzero coefficient becomes plus 1 when the sign of the first nonzero coefficient of the object block specified by said block specifying unit is plus; and the post-rate-conversion nonzero coefficient becomes minus 1 when the sign of the first nonzero coefficient is minus.

11. The coding rate conversion device according to claim 5,
wherein the nonzero coefficient of the coded data is a DCT (Discrete Cosine Transform) coefficient having a nonzero value.

12. The coding rate conversion device according to claim 11,
wherein a coding method used for the first coded data is an MPEG (Moving Picture Experts Group) standard.

13. A coding rate conversion method whereby rate conversion is performed on first coded data by inversely quantizing the first coded data having been quantized with a first quantization step and by requantizing the first coded data with a second quantization step larger in step size than the first quantization step, said coding rate conversion method comprising:
specifying an object block which has a nonzero coefficient, out of a plurality of blocks included in the first coded data; and
performing non-zeroing processing by which a first nonzero coefficient of the specified object block becomes a nonzero coefficient even after the rate conversion is performed using the second quantization step, when the rate conversion is performed on the specified object block.

14. An integrated circuit which performs rate conversion on first coded data by inversely quantizing the first coded data having been quantized with a first quantization step and by requantizing the first coded data with a second quantization step larger in step size than the first quantization step, said integrated circuit comprising:
a block specifying unit configured to specify an object block which has a nonzero coefficient, out of a plurality of blocks included in the first coded data; and
a non-zeroing unit configured to perform non-zeroing processing by which a first nonzero coefficient of the specified object block becomes a nonzero coefficient even after the rate conversion is performed using the second quantization step, when the rate conversion is performed on the specified object block.
